(19) United States
(12) Patent Application Publication
(10) Pub. No.: US 2026/0177800 A1
(43) Pub. Date: Jun. 25, 2026

(54) MICROSCOPE OBJECTIVE

(71) Applicant: Changzhou AAC Raytech Optronics Co., Ltd., Changzhou City (CN)

(72) Inventor: Kenji Oinuma, Osaka (JP)

(21) Appl. No.: 18/988,825

(22) Filed: Dec. 19, 2024

(51) Int. Cl. G02B 21/02; G02B 9/64; G02B 13/00

(52) U.S. Cl. CPC G02B 21/02; G02B 9/64; G02B 13/006

(57) ABSTRACT

A microscope objective sequentially includes from an exit side to an object side: a first lens having positive refractive power, a second lens having negative refractive power, a third lens having negative refractive power, a fourth lens having negative refractive power, a fifth lens having positive refractive power, a sixth lens having positive refractive power, a seventh lens having negative refractive power, an eighth lens having positive or negative refractive power, a ninth lens having positive refractive power, a tenth lens having positive refractive power, an eleventh lens having negative refractive power, a twelfth lens having positive refractive power, a thirteenth lens having negative refractive power, and a fourteenth lens having positive refractive power. Following relational expressions are satisfied: 1.60≤f9/f≤4.00; −3.00≤f10_11/f12_13≤−1.40; −9.00≤(R27+R28)/(R27−R28)≤−1.60; 0.05≤WD/TTL≤0.13; 2.40≤WD*NA≤5.50. The microscope objective has compact structure, has excellent optical performance, and meets the design requirements of low distortion, magnification of 10 times and long working distance.

### CROSS-REFERENCE TO RELATED APPLICATIONS

This application is a continuation of International Application No. PCT/CN2024/094304, filed on May 20, 2024, which is hereby incorporated by reference in its entirety.

### TECHNICAL FIELD

The present disclosure relates to the technical field of optics, and in particular, to a microscope objective suitable for devices such as a microscope.

### BACKGROUND

In recent years, with the increasing requirements for microscope lenses, general microscope lenses can have distortion within their microscopic range due to constraints of their optical structure. In addition, since the microscope lens is composed of multiple lenses, its length is inevitably affected. The microscope lens with long structure can also shorten its working distance, its working distance then affects the magnification, which is not conducive to the use of operators.

With the development of technology and the increase of diversified requirements of users, the requirements of scientific research on observation quality of microscope lenses are continuously improved. There is an urgent need for microscope lenses with excellent optical characteristics, low distortion, high magnification, and long working distance characteristics.

### SUMMARY

The present disclosure aims to provide a microscope objective, which has a large numerical aperture, a compact lens structure, and good optical performance.

In order to solve the above technical problem, the present disclosure provides a microscope objective. The microscope objective sequentially includes from an exit side to an object side: a first lens having positive refractive power, a second lens having negative refractive power, a third lens having negative refractive power, a fourth lens having negative refractive power, a fifth lens having positive refractive power, a sixth lens having positive refractive power, a seventh lens having negative refractive power, an eighth lens having positive or negative refractive power, a ninth lens having positive refractive power, a tenth lens having positive refractive power, an eleventh lens having negative refractive power, a twelfth lens having positive refractive power, a thirteenth lens having negative refractive power, and a fourteenth lens having positive refractive power. A focal length of the ninth lens is f9, a combined focal length of the tenth lens and the eleventh lens is f10_11, a combined focal length of the twelfth lens and the thirteenth lens is f12_13, a curvature radius of an exit surface of the fourteenth lens is R27, a curvature radius of an object-side surface of the fourteenth lens is R28, a focal length of the microscope objective is f, an on-axis distance from an object surface of the microscope objective to the object surface of the fourteenth lens is WD, an on-axis distance from the object-side surface of the microscope objective to an exit surface of the first lens is TTL, and a numerical aperture of the microscope objective is NA, and following relational expressions are satisfied:

$$1.6 \leq f 9 / f \leq 4. ;$$

$$- 3. \leq f 10 \_ 11 / f 12 \_ 13 \leq - 1.4 ;$$

$$- 9. 0 \leq ( R 27 + R 28 ) / ( R 27 - R 28 ) \leq - 1.6 ;$$

$$0.05 \leq WD / TTL \leq 0.13 ; and$$

$$2. 40 \leq WD * NA \leq 5.50 .$$

As an improvement, an object-side surface of the fourth lens and an exit surface of the fifth lens are glued to form a first combined lens, an object-side surface of the seventh lens and an exit surface of the eighth lens are glued to form a second combined lens, an object-side surface of the tenth lens and an exit surface of the eleventh lens are glued to form a third combined lens, an object-side surface of the twelfth lens and an exit surface of the thirteenth lens are glued to form a fourth combined lens, and a difference in Abbe number between two lenses in any one combined lens is Δv, and a following relational expression is satisfied:

$$Δ v \geq 35. .$$

As an improvement, an exit surface of the first lens is convex in a paraxial region, and an object-side surface of the first lens is convex in the paraxial region; a curvature radius of an exit surface of the first lens is R1, a curvature radius of an object-side surface of the first lens is R2, a focal length of the first lens is f1, and an on-axis thickness of the first lens is d1, and following relational expressions are satisfied:

$$- 1.57 \leq ( R 1 + R 2 ) / ( R 1 - R 2 ) \leq 0. ;$$

$$0.67 \leq f 1 / f \leq 3.23 ; and$$

$$0.01 \leq d 1 / TTL \leq 0.07 .$$

As an improvement, an exit surface of the second lens is concave in a paraxial region, and an object-side surface of the second lens is concave in the paraxial region; a curvature radius of an exit surface of the second lens is R3, a curvature radius of an object-side surface of the second lens is R4, a focal length of the second lens is f2, and an on-axis thickness of the second lens is d3, and following relational expressions are satisfied:

$$0.22 \leq ( R 3 + R 4 ) / ( R 3 - R 4 ) \leq 1.38 ;$$

$$- 2.41 \leq f 2 / f \leq - 0 \text{.71} ; and$$

$$0.01 \leq d 3 / TTL \leq 0.02 .$$

As an improvement, an exit surface of the third lens is concave in a paraxial region, and an object-side surface of the third lens is convex in the paraxial region; a curvature radius of an exit surface of the third lens is R5, a curvature radius of an object-side surface of the third lens is R6, a focal length of the third lens is f3, and an on-axis thickness of the third lens is d5, and following relational expressions are satisfied:

$$- 7.51 \leq ( R 5 + R 6 ) / ( R 5 - R 6 ) \leq - 1.63 ;$$

$$- 4.3 \; 3 \leq f 3 / f \leq - 1 \text{.18} ; and$$

$$0.01 \leq d 5 / TTL \leq 0.08 .$$

As an improvement, an exit surface of the fourth lens is concave in a paraxial region, and an object-side surface of the fourth lens is convex in the paraxial region; a curvature radius of an exit surface of the fourth lens is R7, a curvature radius of an object-side surface of the fourth lens is R8, a focal length of the fourth lens is f4, and an on-axis thickness of the fourth lens is d7, and following relational expressions are satisfied:

$$0.61 \leq ( R 7 + R 8 ) / ( R 7 - R 8 ) \leq 2.26 ;$$

$$- 5.94 \leq f 4 / f \leq - 1.57 ; and$$

$$0.04 \leq d 7 / TTL \leq 0.16 .$$

As an improvement, an exit surface of the fifth lens is concave in a paraxial region, and an object-side surface of the fifth lens is convex in the paraxial region; a curvature radius of an exit surface of the fifth lens is R9, a curvature radius of an object-side surface of the fifth lens is R10, a focal length of the fifth lens is f5, and an on-axis thickness of the fifth lens is d9, and following relational expressions are satisfied:

$$- 9.50 \leq ( R 9 + R 10 ) / ( R 9 - R 10 ) \leq - 2 \text{.61} ;$$

$$1.09 \leq f 5 / f \leq 3.49 ; and$$

$$0.01 \leq d 9 / TTL \leq 0.06 .$$

As an improvement, an object-side surface of the fourth lens and an exit surface of the fifth lens are glued to form a combined lens having positive refractive power, and a combined focal length of the fourth lens and the fifth lens is f4_5, and a following relational expression is satisfied:

$$1.35 \leq f 4 \_ 5 / f \leq 4.75 .$$

As an improvement, an exit surface of the sixth lens is convex in a paraxial region, and an object-side surface of the sixth lens is convex in the paraxial region; a curvature radius of an exit surface of the sixth lens is R11, a curvature radius of an object-side surface of the sixth lens is R12, a focal length of the sixth lens is f6, and an on-axis thickness of the sixth lens is d11, and following relational expressions are satisfied:

$$0.18 \leq ( R 11 + R 12 ) / ( R 11 - R 12 ) \leq 1.26 ;$$

$$0.98 \leq f 6 / f \leq 3.59 ; and$$

$$0.02 \leq d 11 / TTL \leq 0.14 .$$

As an improvement, an exit surface of the seventh lens is convex in a paraxial region, and an object-side surface of the seventh lens is concave in the paraxial region; a curvature radius of an exit surface of the seventh lens is R13, a curvature radius of an object-side surface of the seventh lens is R14, a focal length of the seventh lens is f7, and an on-axis thickness of the seventh lens is d13, and following relational expressions are satisfied:

$$- 0.43 \leq ( R 13 + R 14 ) / ( R 13 - R 14 ) \leq 0.25 ;$$

$$- 4.27 \leq f 7 / f \leq - 1 \text{.15} ; and$$

$$0.01 \leq d 13 / TTL \leq 0.04 .$$

As an improvement, an exit surface of the eighth lens is concave in a paraxial region; a curvature radius of an exit surface of the eighth lens is R15, a curvature radius of an object-side surface of the eighth lens is R16, a focal length of the eighth lens is f8, and an on-axis thickness of the eighth lens is d15, and following relational expressions are satisfied:

$$- 3.39 \leq ( R 15 + R 16 ) / ( R 15 - R 16 ) \leq 0.11 ;$$

$$- 7.3 \; 2 \leq f 8 / f \leq 20 \text{.86} ; and$$

$$0.03 \leq d 15 / TTL \leq 0.17 .$$

As an improvement, an object-side surface of the seventh lens and an exit surface of the eighth lens are glued to form a combined lens having negative refractive power, and a combined focal length of the seventh lens and the eighth lens is f7_8, and a following relational expression is satisfied:

$$- 9.03 \leq f 7 \_ 8 / f \leq - 0.95 .$$

As an improvement, an exit surface of the ninth lens is concave in a paraxial region, and an object-side surface of the ninth lens is convex in the paraxial region; a curvature radius of an exit surface of the ninth lens is R17, a curvature radius of an object-side surface of the ninth lens is R18, and an on-axis thickness of the ninth lens is d17, and following relational expressions are satisfied:

$$- 0.06 \leq ( R 17 + R 18 ) / ( R 17 - R 18 ) \leq 0.6 ; and$$

$$0.03 \leq d 17 / TTL \leq 0.17 .$$

As an improvement, an exit surface of the tenth lens is concave in a paraxial region, and an object-side surface of the tenth lens is concave in the paraxial region; a curvature radius of an exit surface of the tenth lens is R19, a curvature radius of an object-side surface of the tenth lens is R20, a focal length of the tenth lens is f10, and an on-axis thickness of the tenth lens is d19, and following relational expressions are satisfied:

$$2.1 \leq ( R 19 + R 20 ) / ( R 19 - R 20 ) \leq 8.39 ;$$

$$1.83 \leq f 10 / f \leq 7 \text{.29} ; and$$

$$0.01 \leq d 19 / TTL \leq 0.02 .$$

As an improvement, an exit surface of the eleventh lens is concave in a paraxial region, and an object-side surface of the eleventh lens is convex in the paraxial region; a curvature radius of an exit surface of the eleventh lens is R21, a curvature radius of an object-side surface of the eleventh lens is R22, a focal length of the eleventh lens is f11, and an on-axis thickness of the eleventh lens is d21, and following relational expressions are satisfied:

$$- 1.8 \leq ( R 21 + R 22 ) / ( R 21 - R 22 ) \leq - 0 \text{.38} ;$$

$$- 13.59 \leq f 11 / f \leq - 1.56 ; and$$

$$0.05 \leq d 21 / TTL \leq 0.19 .$$

As an improvement, an object-side surface of the tenth lens and an exit surface of the eleventh lens are glued to form a combined lens having positive refractive power, and a following relational expression is satisfied:

$$1. 25 \leq f10\_ 11 / f \leq 6.42 .$$

As an improvement, an exit surface of the twelfth lens is concave in a paraxial region; a curvature radius of an exit surface of the twelfth lens is R23, a curvature radius of an object-side surface of the twelfth lens is R24, a focal length of the twelfth lens is f12, and an on-axis thickness of the twelfth lens is d23, and following relational expressions are satisfied:

$$- 4.79 \leq ( R 23 + R 24 ) / ( R 23 - R 24 ) \leq - 0 \text{.41} ;$$

$$0.49 \leq f 12 / f \leq 2.89 ; and$$

$$0.02 \leq d 23 / TTL \leq 0.08 .$$

As an improvement, an object-side surface of the thirteenth lens is concave in a paraxial region; a curvature radius of an exit surface of the thirteenth lens is R25, a curvature radius of an object-side surface of the thirteenth lens is R26, a focal length of the thirteenth lens is f13, and an on-axis thickness of the thirteenth lens is d25, and following relational expressions are satisfied:

$$0.36 \leq ( R 25 + R 26 ) / ( R 25 - R 26 ) \leq 2.47 ;$$

$$- 1.62 \leq f 13 / f \leq - 0 \text{.33} ; and$$

$$0.01 \leq d 25 / TTL \leq 0.09 .$$

As an improvement, an object-side surface of the twelfth lens and an exit surface of the thirteenth lens are glued to form a combined lens having negative refractive power, and a following relational expression is satisfied:

$$- 4.11 \leq f12\_ 13 / f \leq - 0.97 .$$

As an improvement, an exit surface of the fourteenth lens is concave in a paraxial region, and an object-side surface of the fourteenth lens is concave in the paraxial region; a focal length of the fourteenth lens is f14, and an on-axis thickness of the fourteenth lens is d27, and following relational expressions are satisfied:

$$0.71 \leq f 14 / f \leq 3.74 ; and$$

$$0.01 \leq d 27 / TTL \leq 0.15 .$$

The present disclosure has the following beneficial effects: Through the configuration mode of the lenses, the path of light between the lenses can be controlled, stable propagation of the light after the light enters the lens group is facilitated, the lens structure is compact, the total length of the lens assembly is controlled under the condition that the imaging range reaches the expected state, the microscope objective has a large numerical aperture, the light is ensured to have sufficient convergence capability, the optical performance is excellent, and the design requirements of low distortion, magnification of 10 times and long working distance are met.

### BRIEF DESCRIPTION OF DRAWINGS

Many aspects of the exemplary embodiment can be better understood with reference to following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a microscope objective according to Example 1 of the present disclosure;

FIG. 2 is a schematic diagram of a field curvature and distortion of the microscope objective shown in FIG. 1;

FIG. 3 is a schematic diagram of a lateral color of the microscope objective shown in FIG. 1;

FIG. 4 is a schematic diagram of a longitudinal aberration of the microscope objective shown in FIG. 1;

FIG. 5 is a structural schematic diagram of a microscope objective according to Example 2 of the present disclosure;

FIG. 6 is a schematic diagram of a field curvature and distortion of the microscope objective shown in FIG. 5;

FIG. 7 is a schematic diagram of a lateral color of the microscope objective shown in FIG. 5;

FIG. 8 is a schematic diagram of a longitudinal aberration of the microscope objective shown in FIG. 5;

FIG. 9 is a structural schematic diagram of a microscope objective according to Example 3 of the present disclosure;

FIG. 10 is a schematic diagram of a field curvature and distortion of the microscope objective shown in FIG. 9;

FIG. 11 is a schematic diagram of a lateral color of the microscope objective shown in FIG. 9;

FIG. 12 is a schematic diagram of a longitudinal aberration of the microscope objective shown in FIG. 9;

FIG. 13 is a structural schematic diagram of a microscope objective according to Example 4 of the present disclosure;

FIG. 14 is a schematic diagram of a field curvature and distortion of the microscope objective shown in FIG. 13;

FIG. 15 is a schematic diagram of a lateral color of the microscope objective shown in FIG. 13; and

FIG. 16 is a schematic diagram of a longitudinal aberration of the microscope objective shown in FIG. 13.

### DESCRIPTION OF EMBODIMENTS

In order to more clearly illustrate objectives, technical solutions, and advantages of the embodiments of the present disclosure, the technical solutions in the embodiments of the present disclosure are clearly and completely described in details with reference to the drawings. However, those of ordinary skill in the art will appreciate that in various embodiments of the present disclosure, numerous technical details are set forth for the reader to better understand the present disclosure. However, even without these technical details and various variations and modifications based on following embodiments, the technical solutions claimed in the present disclosure can still be implemented.

In the embodiments of the present disclosure, terms such as “upper”, “lower”, “left”, “right”, “front”, “rear”, “top”, “bottom”, “inner”, “outer”, “middle”, “vertical”, “horizontal”, “transverse”, and “longitudinal” indicate that the orientation or position relationship is based on the orientation or position relationship shown in the drawings. These terms are primarily intended to better describe the disclosure and its embodiments, and are not intended to limit that the indicated devices, elements, or components must have a particular orientation, or be constructed and operated in a particular orientation.

In addition, some of the foregoing terms can be used to indicate an orientation or a location relationship, and can also be used to indicate other meanings, for example, the term “upper” can also be used to indicate some attachment relationship or connection relationship in some cases. For those skilled in the art, the specific meanings of these terms in the present disclosure can be understood according to specific situations.

In addition, the terms “install”, “disposed”, “set”, “open”, “connected” and “joined” should be understood broadly. For example, it can be a fixed connection, a detachable connection, or an integral structure; it can be a mechanical connection, or an electrical connection; it can be a direct connection, or an indirect connection through an intermediate medium, or an internal communication between two devices, elements, or components. For those skilled in the art, the specific meaning of the above terms in the present disclosure can be understood according to specific conditions.

In addition, the terms “first”, “second” and the like are mainly used to distinguish different devices, elements or components (specific types and configurations can be the same or different), and are not used to indicate or imply relative importance and quantity of the indicated devices, elements or components. Unless otherwise indicated, “multiple” means two or more.

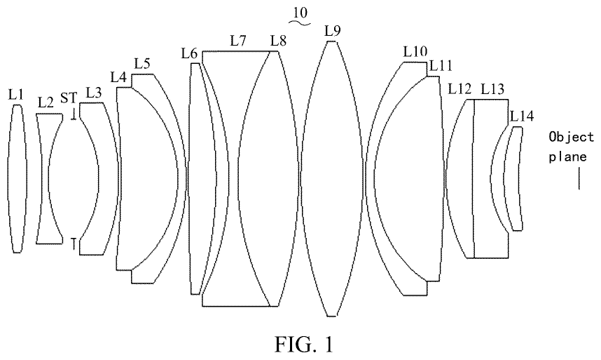

Referring to FIG. 1, the present disclosure provides microscope objectives 10, 20, 30, 40. The microscope objectives 10, 20, 30, 40 sequentially includes from an exit side to an object side: a first lens L1 having positive refractive power, a second lens L2 having negative refractive power, a third lens L3 having negative refractive power, a fourth lens L4 having negative refractive power, a fifth lens L5 having positive refractive power, a sixth lens L6 having positive refractive power, a seventh lens L7 having negative refractive power, an eighth lens L8 having positive or negative refractive power, a ninth lens L9 having positive refractive power, a tenth lens L10 having positive refractive power, an eleventh lens L11 having negative refractive power, a twelfth lens L12 having positive refractive power, a thirteenth lens L13 having negative refractive power, and a fourteenth lens L14 having positive refractive power.

A focal length of the ninth lens L9 is f9, a combined focal length of the tenth lens L10 and the eleventh lens L11 is f10_11, a combined focal length of the twelfth lens L12 and the thirteenth lens L13 is f12_13, a curvature radius of an exit surface of the fourteenth lens L14 is R28, a focal length of the microscope objectives 10, 20, 30, 40 is f, an on-axis distance from an object surface of the microscope objectives 10, 20, 30, 40 to an object-side surface of the fourteenth lens L14 is WD, that is, a working distance is WD, an on-axis distance from an object surface of the microscope objectives 10, 20, 30, 40 to an exit surface of the first lens L1 is TTL, that is, a total optical length is TTL, and a numerical aperture of the microscope objectives 10, 20, 30, 40 is NA, and following relational expressions are satisfied:

$$1. 60 \leq f 9 / f \leq 4. ; \qquad ( 1 )$$

$$- 3. \leq f10\_ 11 / f12\_ 13 \leq - 1.4 ; \qquad ( 2 )$$

$$- 9. \leq ( R 27 + R 28 ) / ( R 27 - R 28 ) \leq - 1.6 ; \qquad ( 3 )$$

$$0.05 \leq WD / TTL \leq 0.13 ; and \qquad ( 4 )$$

$$2. 40 \leq WD * NA \leq 5 \text{.50} . \qquad ( 5 )$$

The relational expression (1) defines a range of a ratio of the focal length f9 of the ninth lens L9 to the focal length f of the microscope objectives 10, 20, 30, 40. Within the above range of the relational expression, it can be ensured that light has sufficient convergence capability, which helps smooth propagation of light.

The relational expression (2) defines a ratio range of the combined focal length f10_11 of the combined lens composed of the tenth lens L10 and the eleventh lens L11 to the combined focal length f12_13 of the twelfth lens L12 and the thirteenth lens L13. Within the above range of the relational expression, it is beneficial to control the direction of light between adjacent combined lens groups while achieving a compact lens structure.

The relational expression (3) defines a shape of the fourteenth lens L14, and the fourteenth lens L14 is a lens closest to a measured object, which facilitates the smooth propagation of light after entering the microscope objectives 10, 20, 30, 40 by controlling the shape of the microscope objectives 10, 20, 30, 40.

The relational expression (4) defines a range of the ratio of the working distance WD of the microscope objectives 10, 20, 30, 40 to the total optical length TTL thereof. If it is less than the lower limit value of the relational expression (4), the distance between the microscope objectives 10, 20, 30, 40 and the measured object is too narrow, and the operability is poor; otherwise, if it is greater than the upper limit value, the lens parts of the microscope objectives 10, 20, 30, 40 occupy insufficient space, resulting in that the thickness and the optical path of the configurable lens are limited, and the spherical aberration and the chromatic aberration are difficult to correct. Therefore, within this range, the working distance WD and the total optical length TTL of the microscope objectives 10, 20, 30, 40 can be effectively balanced, thereby improving the operability of the microscope objectives 10, 20, 30, 40, facilitating the configuration of lenses and optical paths, and further better correcting spherical aberration and chromatic aberration.

The relational expression (5) defines a value range of product of the working distance WD and the numerical aperture NA of the microscope objectives 10, 20, 30, 40. By defining the upper limit thereof, the working distance WD of the microscope objectives 10, 20, 30, 40 can be prevented from being too long relative to the numerical aperture NA, thereby achieving satisfactory aberration performance and higher resolution. In addition, by defining the lower limit of the product, it is possible to avoid the working distance WD being too short, and the user does not need to pay too attention to prevent the objective lens from colliding with the measured object, thereby improving the working efficiency during measurement. In particular, when a microscope objective is used for observation, it is common to use an objective lens with a low numerical aperture to observe an object with a very uneven surface, and the present disclosure can ensure that the low numerical aperture objective lens has a long enough working distance by limiting the lower limit of WD*NA. As a result, even a measured object having a large surface unevenness can be measured, and thus high universality of the microscope objective can be achieved. In other words, it can be ensured that the microscope objective 10, 20, 30, 40 have sufficient resolution and high working efficiency and universality within the range defined in the relational expression (5).

In this solution, through the arrangement, the path of light between the lenses can be controlled, stable propagation of the light after the light enters the lens group is facilitated, the lens structure is compact, the total length of the lens assembly is controlled under the condition that the imaging range reaches the expected state, the microscope objective has a large numerical aperture, the light is ensured to have sufficient convergence capability, the optical performance is excellent, and the design requirements of low distortion, magnification of 10 times and long working distance are met.

It should be noted that the units of the focal length, the thickness, the image height and the total optical length are millimeters.

Optionally, an object-side surface of the fourth lens L4 and an exit surface of the fifth lens L5 are glued to form a first combined lens, an object-side surface of the seventh lens L7 and an exit surface of the eighth lens L8 are glued to form a second combined lens, an object-side surface of the tenth lens L10 and an exit surface of the eleventh lens L11 are glued to form a third combined lens, an object-side surface of the twelfth lens L12 and an exit surface of the thirteenth lens L13 are glued to form a fourth combined lens, and a difference in Abbe number between two lenses in any one combined lens is Δv, and a following relational expression is satisfied:

$$Δ v \geq 35. . \qquad ( 6 )$$

The relational expression (6) defines a range of a difference between dispersion coefficients of two lenses in any combined lens. Within the above range of the relational expression, chromatic aberration of the system can be effectively corrected, so that chromatic aberration |LC|≤0.4 μm.

In this solution, an exit surface of the first lens L1 is convex in a paraxial region, and an object-side surface of the first lens L1 is convex in the paraxial region. In other optional solutions, an object-side surface and an exit surface of the first lens L1 can also be provided with other concave and convex distribution conditions.

A curvature radius of an exit surface of the first lens L1 is R1, a curvature radius of an object-side surface of the first lens L1 is R2, a focal length of the first lens L1 is f1, and an on-axis thickness of the first lens L1 is d1, and a following relational expression is satisfied:

$$- 1.57 \leq ( R 1 + R 2 ) / ( R 1 - R 2 ) \leq 0. ; \qquad ( 7 )$$

$$0.67 \leq f 1 / f \leq 3.23 ; and \qquad ( 8 )$$

$$0.01 \leq d 1 / TTL \leq 0 \text{.07} . \qquad ( 9 )$$

The relational expression (7) defines a shape of the first lens L1, so that the first lens L1 can effectively correct the spherical aberration of the system. Optionally, −0.98≤(R1+R2)/(R1−R2)≤0.00. The relational expression (8) defines a range of a ratio of the focal length f1 of the first lens L1 to the focal length f of the microscope objectives 10, 20, 30, 40. Within the above range of the relational expression, the optical performance of the microscope objectives 10, 20, 30, 40 can be improved. Optionally, 1.08≤f1/f≤2.59. The relational expression (9) defines a range of a ratio of the on-axis thickness d1 of the first lens L1 to the total optical length TTL of the microscope objectives 10, 20, 30, 40. Within the above range of the relational expression, the total optical length TTL of the microscope objectives 10, 20, 30, 40 can be reasonably controlled. Optionally, 0.02≤d1/TTL≤0.06.

In the present disclosure, an exit surface of the second lens is concave in a paraxial region, and an object-side surface of the second lens is concave in the paraxial region. In other optional solutions, an object-side surface and an exit surface of the second lens L2 can also be provided with other concave and convex distribution conditions.

Optionally, a curvature radius of an exit surface of the second lens L2 is R3, a curvature radius of an object-side surface of the second lens L2 is R4, a focal length of the second lens L2 is f2, and an on-axis thickness of the second lens L2 is d3, and following relational expressions are satisfied:

$$0. 22 \leq ( R 3 + R 4 ) / ( R 3 - R 4 ) \leq 1.38 ; \qquad ( 10 )$$

$$- 2.41 \leq f 2 / f \leq - 0 \text{.71} ; and \qquad ( 11 )$$

$$0.01 \leq d 3 / TTL \leq 0 \text{.02} . \qquad ( 12 )$$

The relational expression (10) defines a shape of the second lens. Within the above range of the relational expression (10), the shape of the second lens L2 can be reasonably controlled, the degree of deflection of the light after passing through the second lens L2 can be alleviated, the aberration is effectively reduced. Optionally, 0.36≤(R3+R4)/(R3−R4)≤1.11. The relational expression (11) defines a ratio of the focal length f2 of the second lens L2 to the focal length f of the microscope objectives 10, 20, 30, 40. Within the above range of the relational expression, it helps to reduce aberration and improve imaging quality. Optionally, −1.51≤f2/f≤−0.89. The relational expression (12) defines a range of a ratio of the on-axis thickness d3 of the second lens L2 to the total optical length TTL of the microscope objectives 10, 20, 30, 40, it helps to reasonably control the total optical length of the microscope objectives 10, 20, 30, 40.

In this solution, an exit surface of the third lens is concave in a paraxial region, and an object-side surface of the third lens is convex in the paraxial region. In other optional solutions, the object-side surface and the exit surface of the third lens L3 can also be provided with other concave and convex distribution conditions.

Optionally, a curvature radius of an exit surface of the third lens L3 is R5, a curvature radius of an object-side surface of the third lens L3 is R6, a focal length of the third lens L3 is f3, and an on-axis thickness of the third lens L3 is d5, and following relational expressions are satisfied:

$$- 7.51 \leq ( R 5 + R 6 ) / ( R 5 - R 6 ) \leq - 1.63 ; \qquad ( 13 )$$

$$- 4.33 \leq f 3 / f \leq - 1 \text{.18} ; and \qquad ( 14 )$$

$$0.01 \leq d 5 / TTL \leq 0 \text{.08} . \qquad ( 15 )$$

The relational expression (13) defines a shape of the third lens L3. Within the above range of the relational expression (13), it is beneficial to correct the problem such as the off-axis aberration. Optionally, −4.70≤(R5+R6)/(R5−R6)≤−2.04. The relational expression (14) defines a ratio of the focal length f3 of the third lens L3 to the focal length f of the microscope objectives 10, 20, 30, 40. Within the above range of the relational expression, it helps to improve the optical performance of the system. Optionally, −2.70≤f3/f≤−1.47. The relational expression (15) defines the on-axis thickness d5 of the third lens L3, it is beneficial to reasonably control the total optical length of the microscopic objectives 10, 20, 30, 40. Optionally, 0.02≤d5/TTL≤0.06.

In this solution, an exit surface of the fourth lens L4 is concave in a paraxial region, and an object-side surface of the fourth lens L4 is convex in the paraxial region. In other optional solutions, the object-side surface and the exit surface of the fourth lens L4 can be provided with other concave and convex distributions.

Optionally, a curvature radius of an exit surface of the fourth lens L4 is R7, a curvature radius of an object-side surface of the fourth lens L4 is R8, a focal length of the fourth lens L4 is f4, and an on-axis thickness of the fourth lens L4 is d7, and following relational expressions are satisfied:

$$0.61 \leq ( R 7 + R 8 ) / ( R 7 - R 8 ) \leq 2.26 ; \qquad ( 16 )$$

$$- 5.94 \leq f 4 / f \leq - 1.57 ; and \qquad ( 17 )$$

$$0.04 \leq d 7 / TTL \leq 0 \text{.16} . \qquad ( 18 )$$

The relational expression (16) defines a shape of the fourth lens LA, which helps to reduce the aberration of the microscope objectives 10, 20, 30, 40. Optionally, 0.97≤(R7+R8)/(R7−R8)≤1.81. The relational expression (17) defines a ratio of the focal length f4 of the fourth lens L4 to the focal length f of the microscope objectives 10, 20, 30, 40. Within the above range of the relational expression, it helps to reduce aberration and improve imaging quality. Optionally, −3.71≤f4/f≤−1.96. The relational expression (18) defines a range of a ratio of the on-axis thickness d7 of the fourth lens L4 to the total optical length TTL of the microscope objectives 10, 20, 30, 40. Within the above range of the relational expression, the total optical length TTL of the microscope objectives 10, 20, 30, 40 can be reasonably controlled. Optionally, 0.06≤d7/TTL≤0.13.

In this solution, an exit surface of the fifth lens L5 is concave in a paraxial region, and an object-side surface of the fifth lens L5 is convex in the paraxial region. In other optional solutions, the object-side surface and the exit surface of the fifth lens L5 can also be provided with other concave and convex distributions.

Optionally, a curvature radius of an exit surface of the fifth lens L5 is R9, a curvature radius of an object-side surface of the fifth lens L5 is R10, a focal length of the fifth lens L5 is f5, and an on-axis thickness of the fifth lens L5 is d9, and following relational expressions are satisfied:

$$- 9.50 \leq ( R 9 + R 10 ) / ( R 9 - R 10 ) \leq - 2 \text{.61} ; \qquad ( 19 )$$

$$1. 09 \leq f 5 / f \leq 3.49 ; and \qquad ( 20 )$$

$$0.01 \leq d 9 / TTL \leq 0 \text{.06} . \qquad ( 21 )$$

The relational expression (19) defines a shape of the fifth lens L5, so that the fifth lens L5 can effectively correct the spherical aberration of the system. Optionally, −5.94≤(R9+R10)/(R9−R10)≤−3.27. The relational expression (20) defines a ratio of the focal length f5 of the fifth lens L5 to the focal length f of the microscope objectives 10, 20, 30, 40. Within the above range of the relational expression, it helps to reduce aberration and improve imaging quality. Optionally, 1.75≤f5/f≤2.79. The relational expression (21) defines a value range of a ratio of the on-axis thickness d9 of the fifth lens L5 to the total optical length TTL of the microscope objectives 10, 20, 30, 40, it is beneficial to reasonably control the total optical length of the microscope objectives 10, 20, 30, 40. Optionally, 0.01≤d9/TTL≤0.05.

In this solution, an exit surface of the fourth lens L4 and an object-side surface of the fifth lens L5 are glued to form a combined lens having positive refractive power, and a combined focal length of the fourth lens L4 and the fifth lens L5 is f4_5, and a following relational expression is satisfied:

$$1. 35 \leq f4\_ 5 / f \leq 4 \text{.75} . \qquad ( 22 )$$

It helps to reduce aberration and improve imaging quality within the range of the relational expression. Optionally, 2.16≤f4_5/f≤3.80.

In this solution, an exit surface of the sixth lens L6 is convex in a paraxial region, and an object-side surface of the first lens L6 is convex in the paraxial region. In other optional solutions, the object-side surface and the exit surface of the sixth lens L6 can also be provided with other concave and convex distributions.

Optionally, a curvature radius of an exit surface of the sixth lens L6 is R11, a curvature radius of an object-side surface of the sixth lens L6 is R12, a focal length of the sixth lens L6 is f6, and an on-axis thickness of the sixth lens L6 is d11, and following relational expressions are satisfied:

$$0.18 \leq ( R 11 + R 12 ) / ( R 11 - R 12 ) \leq 1.26 ; \qquad ( 23 )$$

$$0.98 \leq f 6 / f \leq 3.59 ; and \qquad ( 24 )$$

$$0.02 \leq d 11 / TTL \leq 0 \text{.14} . \qquad ( 25 )$$

The relational expression (23) defines a shape of the sixth lens L6. Within the above range of the relational expression, it helps to reduce the spherical aberration of the microscope objectives 10, 20, 30, 40, and improve the image quality. Optionally, 0.29≤(R11+R12)/(R11−R12)≤1.01. The relational expression (24) defines a ratio of the focal length f6 of the sixth lens L6 to the focal length f of the microscope objectives 10, 20, 30, 40. Within the above range of the relational expression, it helps to reduce aberration and improve imaging quality. Optionally, 1.58≤f6/f≤2.87. The relational expression (25) defines a range of a ratio of the on-axis thickness d11 of the sixth lens L6 to the total optical length TTL of the microscope objectives 10, 20, 30, 40. Within the above range of the relational expression (25), it is beneficial to reasonably control the total optical length of the microscope objectives 10, 20, 30, 40. Optionally, 0.03≤d11/TTL≤0.11.

In this solution, an exit surface of the seventh lens L7 is convex in a paraxial region, and an object-side surface of the seventh lens L7 is concave in the paraxial region. In other optional solutions, the object-side surface and the exit surface of the seventh lens L7 can also be provided with other concave and convex distributions.

Optionally, a curvature radius of an object-side surface of the seventh lens L7 is R13, a curvature radius of an exit surface of the seventh lens L7 is R14, a focal length of the seventh lens L7 is f7, and an on-axis thickness of the seventh lens L7 is d13, and following relational expressions are satisfied:

$$- 0.43 \leq ( R 13 + R 14 ) / ( R 13 - R 14 ) \leq 0.25 ; \qquad ( 26 )$$

$$- 4.27 \leq f 7 / f \leq - 1 \text{.15} ; and \qquad ( 27 )$$

$$0.01 \leq d 13 / TTL \leq 0 \text{.04} . \qquad ( 28 )$$

The relational expression (26) defines a shape of the seventh lens L7, and reasonably controls the shape of the seventh lens L7, it is beneficial to alleviate the degree of deflection of light passing through the microscope objectives 10, 20, 30, 40, so that the system has better imaging quality and lower sensitivity. Optionally, −0.27≤(R13+R14)/≤0.20. The relational expression (27) defines a range of a ratio of the focal length f7 of the seventh lens L7 to the focal length f of the microscope objectives 10, 20, 30, 40. Within the above range of the relational expression, the seventh lens L7 has a proper negative refractive power, it is beneficial to reduce aberration of the system. Optionally, −2.67≤f7/f≤−1.44. The relational expression (28) defines an on-axis thickness d13 of the seventh lens L7. Within the above range of the relational expression (28), it is beneficial to reasonably control the total optical length of the microscope objectives 10, 20, 30, 40. Optionally, 0.01≤d13/TTL≤0.03.

In this solution, an exit surface of the eighth lens L8 is concave in a paraxial region, and an object-side surface of the eighth lens L8 is convex or concave in the paraxial region. In other optional solutions, the exit surface of the eighth lens L8 can also be configured as convex.

Optionally, a curvature radius of an exit surface of the eighth lens L8 is R15, a curvature radius of an object-side surface of the eighth lens L8 is R16, a focal length of the eighth lens L8 is f8, and an on-axis thickness of the eighth lens L8 is d15, and following relational expressions are satisfied:

$$- 3.39 \leq ( R 15 + R 16 ) / ( R 15 - R 16 ) \leq 0.11 ; \qquad ( 29 )$$

$$- 7.3 \; 2 \leq f 8 / f \leq 20.86 ; and \qquad ( 30 )$$

$$0.03 \leq d 15 / TTL \leq 0 \text{.17} . \qquad ( 31 )$$

The relational expression (29) defines a shape of the eighth lens L8. Within the above range of the relational expression, along with the ultra-thin development of the microscope objectives 10, 20, 30, 40, it is beneficial to correct the problem of the on-axis chromatic aberration. Optionally, −2.12≤(R15+R16)/≤0.09. The relational expression (30) defines a ratio of the focal length f8 of the eighth lens L8 to the focal length f of the microscope objectives 10, 20, 30, 40. Within the above range of the relational expression, it helps to improve the optical performance of the microscope objectives 10, 20, 30, 40. Optionally, −4.58≤f8/f≤16.69. The relational expression (31) defines the on-axis thickness d15 of the eighth lens L8, it is beneficial to reasonably control the total optical length of the microscope objectives 10, 20, 30, 40. Optionally, 0.06≤d15/TTL≤0.14.

In this solution, an object-side surface of the seventh lens L7 and an exit surface of the eighth lens L8 are glued to form a combined lens having negative refractive power, and a combined focal length of the seventh lens L7 and the eighth lens L8 is f7_8, and a following relational expression is satisfied:

$$- 9.03 \leq f7\_ 8 / f \leq - 0 \text{.95} . \qquad ( 32 )$$

The relational expression (32) defines a range of a ratio of the combined focal length f7_8 of the combined lens composed of the seventh lens L7 and the eighth lens L8 to the focal length f of the microscope objectives 10, 20, 30, 40. Within the above range of the relational expression, the optical performance of the microscope objectives 10, 20, 30, 40 can be improved. Optionally, −5.64≤f7_8/f≤−1.19.

In this solution, an exit surface of the ninth lens L9 is concave in a paraxial region, and an object-side surface of the first lens L9 is convex in the paraxial region. In other optional solutions, the object-side surface and the exit surface of the ninth lens L9 can also be provided with other concave and convex distribution conditions.

Optionally, a curvature radius of an exit surface of the ninth lens L9 is R17, a curvature radius of an object-side surface of the ninth lens L9 is R18, and an on-axis thickness of the ninth lens L9 is d17, and following relational expressions are satisfied:

$$- 0.06 \leq ( R 17 + R 18 ) / ( R 17 - R 18 ) \leq 0.6 \qquad ( 33 )$$

$$0.03 \leq d 17 / TTL \leq 0 \text{.17} \qquad ( 34 )$$

The relational expression (33) defines a shape of the ninth lens L9, within the range of the relational expression, the ninth lens L9 can effectively correct the spherical aberration of the system, it helps to improve the imaging quality. Optionally, −0.03≤(R17+R18)/(R17−R18)≤0.48. The relational expression (34) defines the on-axis thickness d17 of the ninth lens L9. Within the above range of the relational expression, it helps to reasonably control the total optical length TTL of the microscope objectives 10, 20, 30, 40. Optionally, 0.05≤d17/TTL≤0.13.

In this solution, an exit surface of the tenth lens L10 is concave in a paraxial region, and an object-side surface of the tenth lens L10 is concave in the paraxial region. In other optional solutions, the object-side surface and the exit surface of the tenth lens L10 can also be provided with other concave and convex distribution conditions.

Optionally, a curvature radius of an exit surface of the tenth lens L10 is R19, a curvature radius of an object-side surface of the tenth lens L10 is R20, a focal length of the tenth lens L10 is f10, and an on-axis thickness of the tenth lens L10 is d19, and following relational expressions are satisfied:

$$2.1 \leq ( R 19 + R 20 ) / ( R 19 - R 20 ) \leq 8.39 ; \qquad ( 35 )$$

$$1. 83 \leq f 10 / f \leq 7.29 ; and \qquad ( 36 )$$

$$0.01 \leq d 19 / TTL \leq 0 \text{.02} . \qquad ( 37 )$$

The relational expression (35) defines a shape of the tenth lens L10. Within the above range of the relational expression, the degree of deflection of light passing through the tenth lens L10 can be alleviated, the aberration is effectively reduced. Optionally, 3.36≤(R19+R20)/(R19−R20)≤6.71. The relational expression (36) defines a ratio of the focal length f10 of the tenth lens L10 to the focal length f of the microscope objectives 10, 20, 30, 40. Within the above range of the relational expression, it is beneficial to improve the optical performance of the microscope objectives 10, 20, 30, 40, and improve the imaging quality. Optionally, 2.92≤f10/f≤5.83. The relational expression (37) defines the on-axis thickness d19 of the tenth lens L10. Within the above range of the relational expression, it helps to reasonably control the total optical length of the microscope objectives 10, 20, 30, 40.

In this solution, an exit surface of the eleventh lens L11 is concave in a paraxial region, and an object-side surface of the eleventh lens L11 is convex in the paraxial region. In other optional solutions, the object-side surface and the exit surface of the eleventh lens L11 can also be provided with other concave and convex distribution conditions.

Optionally, a curvature radius of an exit surface of the eleventh lens L11 is R21, a curvature radius of an object-side surface of the eleventh lens L11 is R22, a focal length of the eleventh lens L11 is f11, and an on-axis thickness of the eleventh lens L11 is d21, and following relational expressions are satisfied:

$$- 1.8 \leq ( R 21 + R 22 ) / ( R 21 - R 22 ) \leq - 0.38 ; \qquad ( 38 )$$

$$- 13.59 \leq f 11 / f \leq - 1.56 ; and \qquad ( 39 )$$

$$0.05 \leq d 21 / TTL \leq 0 \text{.19} . \qquad ( 40 )$$

The relational expression (38) defines a shape of the eleventh lens L11. Within the above range of the relational expression, it is beneficial to improve the optical performance of the microscope objectives 10, 20, 30, 40. Optionally, −1.13≤(R21+R22)/(R21−R22)≤−0.47. The relational expression (39) defines a ratio of the focal length f11 of the eleventh lens L11 to the focal length f of the microscope objectives 10, 20, 30, 40. Within the above range of the relational expression, the eleventh lens L11 has a proper negative refractive power, it is beneficial to reduce aberration of the system. Optionally, −8.49≤f11/f≤−1.95. The relational expression (40) defines a ratio of the thickness d21 of the eleventh lens L11 to the total optical length TTL of the microscope objectives 10, 20, 30, 40. Within the above range of the relational expression, it is beneficial to reasonably control the total optical length of the microscope objectives 10, 20, 30, 40. Optionally, 0.08≤d21/TTL≤0.15.

In this solution, an object-side surface of the tenth lens L10 and an exit surface of the eleventh lens L11 are glued to form a combined lens having positive refractive power, and a following relational expression is satisfied:

$$1.25 \leq f10\_ 11 / f \leq 6 \text{.42} . \qquad ( 41 )$$

Within the constraint of the relational expression (41), the optical performance of the microscope objectives 10, 20, 30, 40 can be improved. Optionally, 2.00≤f10_11/f≤5.13.

In this solution, an exit surface of the twelfth lens L12 is concave in a paraxial region, and an object-side surface of the twelfth lens L12 is concave or convex in the paraxial region. In other optional solutions, the exit surface of the twelfth lens L12 can also be configured as convex.

Optionally, a curvature radius of an exit surface of the twelfth lens is R23, a curvature radius of an object-side surface of the twelfth lens is R24, a focal length of the twelfth lens is f12, and an on-axis thickness of the twelfth lens is d23, and following relational expressions are satisfied:

$$- 4.79 \leq ( R 23 + R 24 ) / ( R 23 - R 24 ) \leq - 0.41 ; \qquad ( 42 )$$

$$0. 49 \leq f 12 / f \leq 2.89 ; and \qquad ( 43 )$$

$$0.02 \leq d 23 / TTL \leq 0 \text{.08} . \qquad ( 44 )$$

The relational expression (42) defines a shape of the twelfth lens L12. Within the above range of the relational expression, it is beneficial to correct the problem of the on-axis chromatic aberration. Optionally, −3.00≤(R23+R24)/(R23−R24)≤−0.51. The relational expression (43) defines a ratio of the focal length f12 of the twelfth lens L12 to the focal length f of the microscope objectives 10, 20, 30, 40. Within the above range of the relational expression, the optical performance of the microscope objectives 10, 20, 30, 40 can be improved. Optionally, 0.78≤f12/f≤2.31. The relational expression (44) defines the on-axis thickness d23 of the twelfth lens L12, it helps to reasonably control the total optical length of the microscope objectives 10, 20, 30, 40. Optionally, 0.04≤d23/TTL≤0.07.

In this solution, an exit surface of the thirteenth lens L13 is concave or convex in a paraxial region, and an object-side surface of the thirteenth lens L13 is concave in the paraxial region. In other optional solutions, the object-side surface of the thirteenth lens L13 can also be configured as convex.

Optionally, a curvature radius of an exit surface of the thirteenth lens L13 is R25, a curvature radius of an object-side surface of the thirteenth lens L13 is R26, a focal length of the thirteenth lens L13 is f13, and an on-axis thickness of the thirteenth lens L13 is d25, and following relational expressions are satisfied:

$$0.36 \leq ( R 25 + R 26 ) / ( R 25 - R 26 ) \leq 2.47 ; \qquad ( 45 )$$

$$- 1.62 \leq f 13 / f \leq - 0 \text{.33} ; and \qquad ( 46 )$$

$$0.01 \leq d 25 / TTL \leq 0 \text{.09} . \qquad ( 47 )$$

The relational expression (45) defines a shape of the thirteenth lens L13. Within the above range of the relational expression, it reasonably control the shape of the thirteenth lens L13, the degree of deflection of the light after passing through the thirteenth lens L13 can be alleviated, the aberration is effectively reduced. Optionally, 0.58≤(R25+R26)/(R25−R26)≤1.98. The relational expression (46) defines a range of a ratio of the focal length f13 of the thirteenth lens L13 to the focal length f of the microscope objectives 10, 20, 30, 40, it can improve the optical performance of the microscope objectives 10, 20, 30, 40. Optionally, −1.01≤f13/f≤−0.41. The relational expression (47) defines the on-axis thickness d25 of the thirteenth lens L13, it helps to reasonably control the total optical length of the microscope objectives 10, 20, 30, 40. Optionally, 0.01≤d25/TTL≤0.08.

In this solution, an object-side surface of the twelfth lens L12 and an exit surface of the thirteenth lens L13 are glued to form a combined lens having negative refractive power, and a following relational expression is satisfied:

$$- 4.11 \leq f12\_ 13 / f \leq - 0 \text{.97} . \qquad ( 48 )$$

The relational expression (48) defines a ratio of the focal length f12_13 of the combined lens composed of the twelfth lens L12 and the thirteenth lens L13 to the focal length f of the microscope objectives 10, 20, 30, 40, so that the optical performance of the microscope objectives 10, 20, 30, 40 can be improved. Optionally, −2.57≤f12_13/f≤−1.21.

In this solution, an exit surface of the fourteenth lens L14 is concave in a paraxial region, and an object-side surface of the fourteenth lens L14 is concave in the paraxial region. In other optional solutions, the object-side surface and the exit surface of the fourteenth lens L14 can also be provided with other concave and convex distribution conditions.

Optionally, a focal length of the fourteenth lens L14 is f14, and an on-axis thickness of the fourteenth lens L14 is d27, and following relational expressions are satisfied:

$$0.71 \leq f 14 / f \leq 3.74 ; and \qquad ( 49 )$$

$$0.01 \leq d 27 / TTL \leq 0 \text{.15} . \qquad ( 50 )$$

The relational expression (49) defines a range of the ratio of the focal length of the fourteenth lens L14 to the focal length f of the microscope objectives 10, 20, 30, 40, it helps to reduce the aberration and improve the imaging quality. Optionally, 1.13≤f14/f≤2.99. The relational expression (50) defines the on-axis thickness d27 of the fourteenth lens L14, it helps to reasonably control the total optical length of the microscope objectives 10, 20, 30, 40. Optionally, 0.02≤d27/TTL≤0.12.

In this solution, an aperture ST is disposed between the second lens L2 and the third lens L3.

In this solution, the first lens L1, the second lens L2, the third lens L3, the fourth lens L4, the fifth lens L5, the sixth lens L6, the seventh lens L7, the eighth lens L8, the ninth lens L9, the tenth lens L10, the eleventh lens L11, the twelfth lens L12, the thirteenth lens L13, and the fourteenth lens L14 are all made of glass.

The microscope objectives 10, 20, 30, 40 can control the path of light between the lenses, the lens structure is compact, the total length of the lens assembly is controlled under the condition that the imaging range reaches the expected state, the microscope objectives have a large numerical aperture, light is ensured to have sufficient convergence capability, the optical performance is excellent, and the design requirements of low distortion, magnification of 10 times and long working distance are met.

The microscope objective 10 of the present disclosure will be described below by way of example. The reference signs recited in each example are shown in Table 1, the units of focal length, on-axis distance, curvature radius, on-axis thickness are mm.

The technical solutions of the present disclosure will be described in detail in four examples.

### Example 1

In this example:
the first lens L1 has positive refractive power, its exit surface is convex in a paraxial region and its object-side surface is convex in the paraxial region;
the second lens L2 has negative refractive power, its exit surface is concave in a paraxial region, and its object-side surface is concave in the paraxial region;
the third lens L3 has negative refractive power, its exit surface is concave in a paraxial region, and its object-side surface is convex in the paraxial region;
the fourth lens L4 has negative refractive power, its exit surface is concave in a paraxial region, and its object-side surface is convex in the paraxial region;
the fifth lens L5 has positive refractive power, its exit surface is concave in a paraxial region, and its object-side surface is convex in the paraxial region;
the sixth lens L6 has positive refractive power, its exit surface is convex in a paraxial region, and its object-side surface is convex in the paraxial region;
the seventh lens L7 has negative refractive power, its exit surface is convex in a paraxial region, and its object-side surface is concave in the paraxial region;
the eighth lens L8 has positive refractive power, its exit surface is concave in a paraxial region, and its object-side surface is convex in the paraxial region;
the ninth lens L9 has positive refractive power, its exit surface is concave in a paraxial region, and its object-side surface is convex in the paraxial region;
the tenth lens L10 has positive refractive power, its exit surface is concave in a paraxial region, and its object-side surface is concave in the paraxial region;
the eleventh lens L11 has negative refractive power, its exit surface is concave in a paraxial region, and its object-side surface is convex in the paraxial region;
the twelfth lens L12 has positive refractive power, its exit surface is concave in a paraxial region, and its object-side surface is concave in the paraxial region;
the thirteenth lens L13 has negative refractive power, its exit surface is concave in a paraxial region, and its object-side surface is concave in the paraxial region; and
the fourteenth lens L14 has positive refractive power, its exit surface is concave in a paraxial region, and its object-side surface is concave in the paraxial region.

FIG. 1 is a structural schematic diagram of a microscope objective 10 in Example 1. The design data of the microscope objective 10 in Example 1 of the present disclosure is shown below.

Table 1 lists the curvature radius R, on-axis thickness of lens, on-axis distance d between lenses, refractive index nd, and Abbe number vd of the exit surface and object-side surface of the first to fourteenth lenses L1 to L14 that constitute the microscope objective 10 in Example 1 of the present disclosure. It should be noted that in the examples, the units of the distance, the radius and the thickness are millimeter (mm).

TABLE 1

| | R | d | | nd | | vd | |
|---|---|---|---|---|---|---|---|
| R1 | 61.340 | d1= | 3.150 | nd1 | 1.8830 | vd1 | 40.805 |
| R2 | -61.340 | d2= | 2.610 | | | | |
| R3 | -42.910 | d3= | 1.000 | nd2 | 1.5503 | vd2 | 75.496 |
| R4 | 16.311 | d41= | 4.230 | | | | |
| ST | ∞ | d42= | 4.230 | / | / | / | / |
| R5 | -13.795 | d5= | 3.300 | nd3 | 1.8697 | vd3 | 20.019 |
| R6 | -24.210 | d6= | 0.400 | | | | |
| R7 | -88.864 | d7= | 9.500 | nd4 | 1.5928 | vd4 | 68.624 |
| R8 | -15.031 | d8= | 0.000 | | | | |
| R9 | -15.031 | d9= | 1.400 | nd5 | 1.7705 | vd5 | 29.736 |
| R10 | -23.358 | d10= | 0.400 | | | | |
| R11 | 340.00 | d11= | 4.600 | nd6 | 1.9229 | vd6 | 20.880 |
| R12 | -50.000 | d12= | 2.130 | | | | |
| R13 | -33.533 | d13= | 1.500 | nd7 | 1.6140 | vd7 | 44.293 |
| R14 | 33.533 | d14= | 0.000 | | | | |
| R15 | 33.533 | d15= | 10.150 | nd8 | 1.4370 | vg8 | 95.100 |
| R16 | -51.087 | d16= | 0.400 | | | | |
| R17 | 46.454 | d17= | 10.370 | nd9 | 1.4370 | vg9 | 95.100 |
| R18 | -46.454 | d18= | 0.400 | | | | |
| R19 | 25.400 | d19= | 1.500 | nd10 | 1.6968 | vg10 | 55.460 |
| R20 | 16.789 | d20= | 0.000 | | | | |
| R21 | 16.789 | d21= | 11.600 | nd11 | 1.4370 | vg11 | 95.100 |
| R22 | -145.000 | d22= | 0.400 | | | | |
| R23 | 20.929 | d23= | 4.390 | nd12 | 1.5503 | vg12 | 75.496 |
| R24 | 175.145 | d24= | 0.000 | | | | |
| R25 | 175.145 | d25= | 3.060 | nd13 | 1.7705 | vg13 | 29.736 |
| R26 | 11.949 | d26= | 2.200 | | | | |
| R27 | 18.539 | d27= | 2.480 | nd14 | 2.0010 | vg14 | 29.135 |
| R28 | 34.635 | d28= | 10.100 | | | | |
| Object | ∞ | / | / | / | / | / | / |
| surface | | | | | | | |

The meaning of each symbol in the above table is as follows:
R: curvature radius of the optical surface, and central curvature radius of the lens;
ST: aperture;
R1: curvature radius of the exit surface of the first lens L1;
R2: curvature radius of the object-side surface of the first lens L1;
R3: curvature radius of the exit surface of the second lens L2;
R4: curvature radius of the object-side surface of the second lens L2;
R5: curvature radius of the exit surface of the third lens L3;
R6: curvature radius of the object-side surface of the third lens L3;
R7: curvature radius of the exit surface of the fourth lens L4;
R8: curvature radius of the object-side surface of the fourth lens L4;
R9: curvature radius of the exit surface of the fifth lens L5;
R10: curvature radius of the object-side surface of the fifth lens L5;
R11: curvature radius of the exit surface of the sixth lens L6;
R12: curvature radius of the object-side surface of the sixth lens L6;
R13: curvature radius of the exit surface of the seventh lens L7;
R14: curvature radius of the object-side surface of the seventh lens L7;
R15: curvature radius of the exit surface of the eighth lens L8;
R16: curvature radius of the object-side surface of the eighth lens L8;
R17: curvature radius of the exit surface of the ninth lens L9;
R18: curvature radius of the object-side surface of the ninth lens L9;
R19: curvature radius of the exit surface of the tenth lens L10;
R20: curvature radius of the object-side surface of the tenth lens L10;
R21: curvature radius of the exit surface of the eleventh lens L11;
R22: curvature radius of the object-side surface of the eleventh lens L11;
R23: curvature radius of the exit surface of the twelfth lens L12;
R24: curvature radius of the object-side surface of the twelfth lens L12;
R25: curvature radius of the exit surface of the thirteenth lens L13;
R26: curvature radius of the object-side surface of the thirteenth lens L13;
R27: curvature radius of the exit surface of the fourteenth lens L14;
R28: curvature radius of the object-side surface of the fourteenth lens L14;
d: on-axis thickness of lenses, on-axis distance between lenses;
d1: on-axis thickness of the first lens L1;
d2: on-axis distance from the exit surface of the first lens L1 to the object-side
surface of the second lens L2;
d3: on-axis thickness of the second lens L2;
d41: on-axis distance from the exit surface of the second lens L2 to the aperture ST;
d42: on-axis distance from the aperture ST to the object-side surface of the third lens L3;
d5: on-axis thickness of the third lens L3;
d6: on-axis distance from the exit surface of the third lens L3 to the object-side surface of the fourth lens L4;
d7: on-axis thickness of the fourth lens L4;
d8: on-axis distance from the exit surface of the fourth lens L4 to the object-side surface of the fifth lens L5;
d9: on-axis thickness of the fifth lens L5;
d10: on-axis distance from the exit surface of the fifth lens L5 to the object-side surface of the sixth lens L6;
d11: on-axis thickness of the sixth lens L6;
d12: on-axis distance from the exit surface of the sixth lens L6 to the object-side surface of the seventh lens L7;
d13: on-axis thickness of the seventh lens L7;
d14: on-axis distance from the exit surface of the seventh lens L7 to the object-side surface of the eighth lens L8;
d15: on-axis thickness of the eighth lens L8;
d16: on-axis distance from the exit surface of the eighth lens L8 to the object-side surface of the ninth lens L9;
d17: on-axis thickness of the ninth lens L9;
d18: on-axis distance from the exit surface of the ninth lens L9 to the object-side surface of the tenth lens L10;
d19: on-axis thickness of the tenth lens L10;
d20: on-axis distance from the exit surface of the tenth lens L10 to the object-side surface of the eleventh lens L11;
d21: on-axis thickness of the eleventh lens L11;
d22: on-axis distance from the exit surface of the eleventh lens L11 to the object-side surface of the twelfth lens L12;
d23: on-axis thickness of the twelfth lens L12;
d24: on-axis distance from the exit surface of the twelfth lens L12 to the object-side surface of the thirteenth lens 13;
d25: on-axis thickness of the thirteenth lens L13;
d26: an on-axis distance from the exit surface of the thirteenth lens L13 to the object-side surface of the fourteenth lens L14;
d27: on-axis thickness of the fourteenth lens L14;
d28: on-axis distance from the object-side surface of the fourteenth lens L14 to the object plane obj;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
nd8: refractive index of d line of the eighth lens L8;
nd9: refractive index of d line of the ninth lens L9;
nd10: refractive index of d line of the tenth lens L10;
nd11: refractive index of d line of the eleventh lens L11;
nd12: refractive index of d line of the twelfth lens L12;
nd13: refractive index of d line of the thirteenth lens L13;
nd14: refractive index of d line of the fourteenth lens L14;
vd: Abbe number;
vd1: Abbe number of the first lens L1;
vd2: Abbe number of the second lens L2;
vd3: Abbe number of the third lens L3;
vd4: Abbe number of the fourth lens L4;
vd5: Abbe number of the fifth lens L5;
vd6: Abbe number of the sixth lens L6;
vd7: Abbe number of the seventh lens L7;
vd8: Abbe number of the eighth lens L8;
vd9: Abbe number of the ninth lens L9;
vd10: Abbe number of the tenth lens L10;
vd11: Abbe number of the eleventh lens L11;
vd12: Abbe number of the twelfth lens L12;
vd13: Abbe number of the thirteenth lens L13; and
vd14: Abbe number of the fourteenth lens L14.

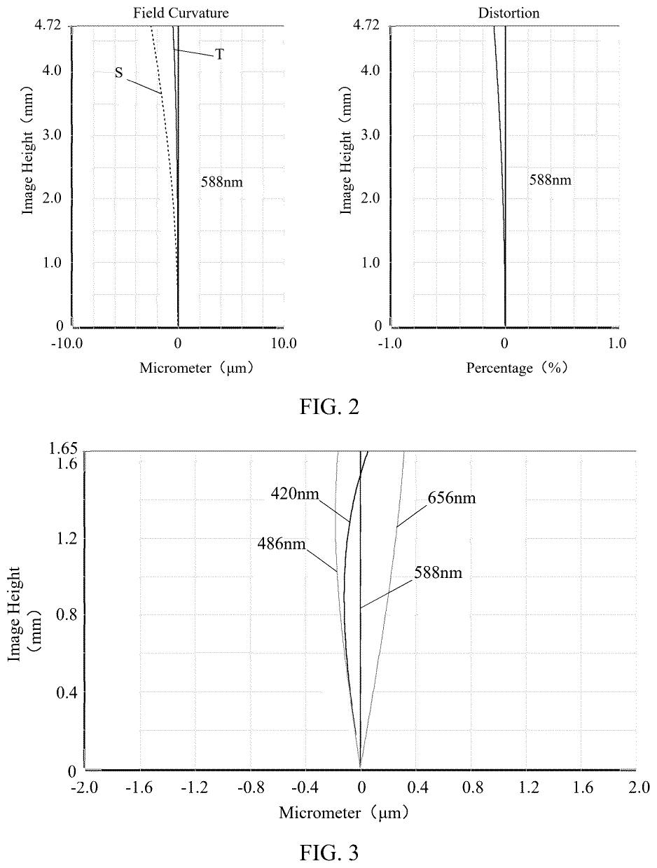

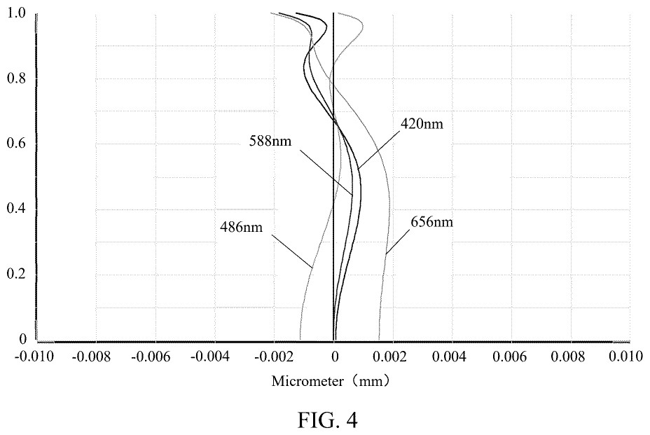

FIG. 2 shows a schematic diagram of field curvature and distortion after light with a wavelength of 588 nm passes through the microscope objective 10 of Example 1, the field curvature S of FIG. 2 is a field curvature in a sagittal direction, and T is a field curvature in a meridian direction. FIG. 3 shows a schematic diagram of lateral color after light with a wavelength of 420 nm, 486 nm, 588 nm and 656 nm passes through the microscope objective 10 of Example 1. FIG. 4 shows a schematic diagram of longitudinal aberration after light with a wavelength of 420 nm, 486 nm, 588 nm and 656 nm passes through the microscope objective 10 of Example 1.

In addition, in the following Table 5, values corresponding to various parameters in Example 1 and parameters defined in the relational expressions are also listed.

As shown in Table 5, Example 1 satisfies each condition formula.

In this example, the entrance pupil diameter of the microscope objective 10 is 19.208 mm, the full field of view image height is 1.65 mm, and the numerical aperture NA is 0.48, the microscope objective 10 can control the path of the light between the lenses, which helps the light to stably propagate after entering the lens group, so that the lens is compact in structure, the total length of the lens is controlled while ensuring that the imaging range reaches the expected state, so that the microscope objective 10 has a large numerical aperture NA, ensures that the light has sufficient convergence capability, has excellent optical performance, and meets the design requirements of low distortion, magnification of 10 times and long working distance.

### Example 2

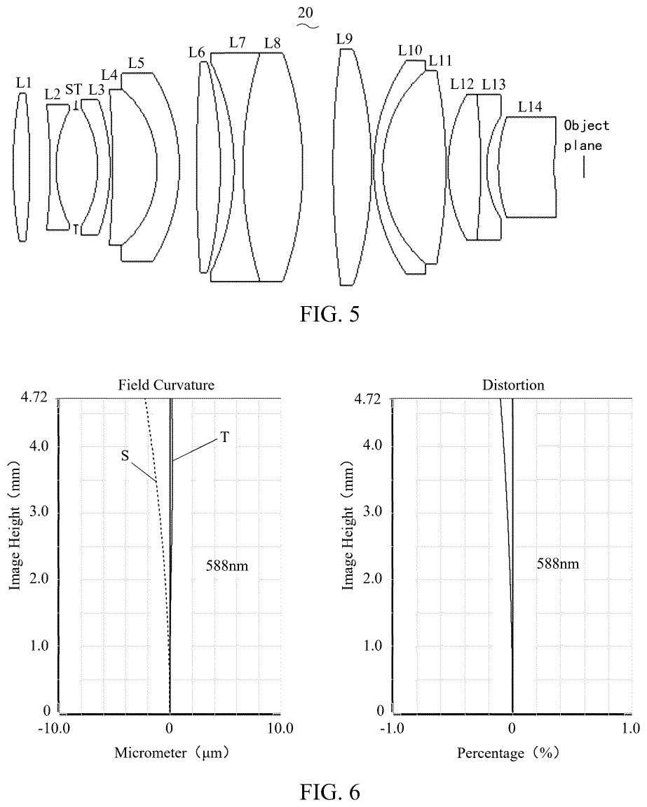

FIG. 5 is a structural schematic diagram of a microscope objective 20 in Example 2, Example 2 is substantially the same as Example 1, the reference signs have the same meaning as Example 1, and only differences are listed below.

In this example, the object-side surface of the twelfth lens L12 is convex in a paraxial region, and the exit surface of the thirteenth lens L13 is convex in the paraxial region.

Table 2 shows design data of the microscope objective 20 according to Example 2 of the present disclosure.

TABLE 2

| | R | d | | nd | | vd | |
|---|---|---|---|---|---|---|---|
| R1 | 54.055 | d1= | 2.780 | nd1 | 1.8830 | vd1 | 40.805 |
| R2 | -82.988 | d2= | 3.397 | | | | |
| R3 | -71.451 | d3= | 1.000 | nd2 | 1.5503 | vd2 | 75.496 |
| R4 | 16.352 | d41= | 3.326 | | | | |
| ST | ∞ | d42= | 3.634 | / | / | / | / |
| R5 | -14.302 | d5= | 2.082 | nd3 | 1.8697 | vd3 | 20.019 |
| R6 | -24.676 | d6= | 0.400 | | | | |
| R7 | -119.897 | d7= | 7.477 | nd4 | 1.5928 | vd4 | 68.624 |
| R8 | -13.562 | d8= | 0.000 | | | | |
| R9 | -13.562 | d9= | 3.699 | nd5 | 1.7705 | vd5 | 29.736 |
| R10 | -22.852 | d10= | 2.884 | | | | |
| R11 | 181.949 | d11= | 3.973 | nd6 | 1.9229 | vd6 | 20.880 |
| R12 | -53.672 | d12= | 2.291 | | | | |
| R13 | -31.179 | d13= | 1.500 | nd7 | 1.6140 | vd7 | 44.293 |
| R14 | 48.467 | d14= | 0.000 | | | | |
| R15 | 48.467 | d15= | 9.988 | nd8 | 1.4370 | vg8 | 95.100 |
| R16 | -41.839 | d16= | 5.064 | | | | |
| R17 | 113.530 | d17= | 6.418 | nd9 | 1.4370 | vg9 | 95.100 |
| R18 | -48.751 | d18= | 0.400 | | | | |
| R19 | 24.330 | d19= | 1.500 | nd10 | 1.6968 | vg10 | 55.460 |
| R20 | 16.949 | d20= | 0.000 | | | | |
| R21 | 16.949 | d21= | 10.553 | nd11 | 1.4370 | vg11 | 95.100 |
| R22 | -61.005 | d22- | 0.400 | | | | |
| R23 | 19.332 | d23= | 5.411 | nd12 | 1.5503 | vg12 | 75.496 |
| R24 | -80.242 | d24= | 0.000 | | | | |
| R25 | -80.242 | d25= | 1.000 | nd13 | 1.7705 | vg13 | 29.736 |
| R26 | 12.064 | d26= | 1.952 | | | | |
| R27 | 19.574 | d27= | 9.366 | nd14 | 2.0010 | vg14 | 29.135 |
| R28 | 24.499 | d28= | 5.006 | | | | |
| Object | ∞ | / | / | / | / | / | / |
| surface | | | | | | | |

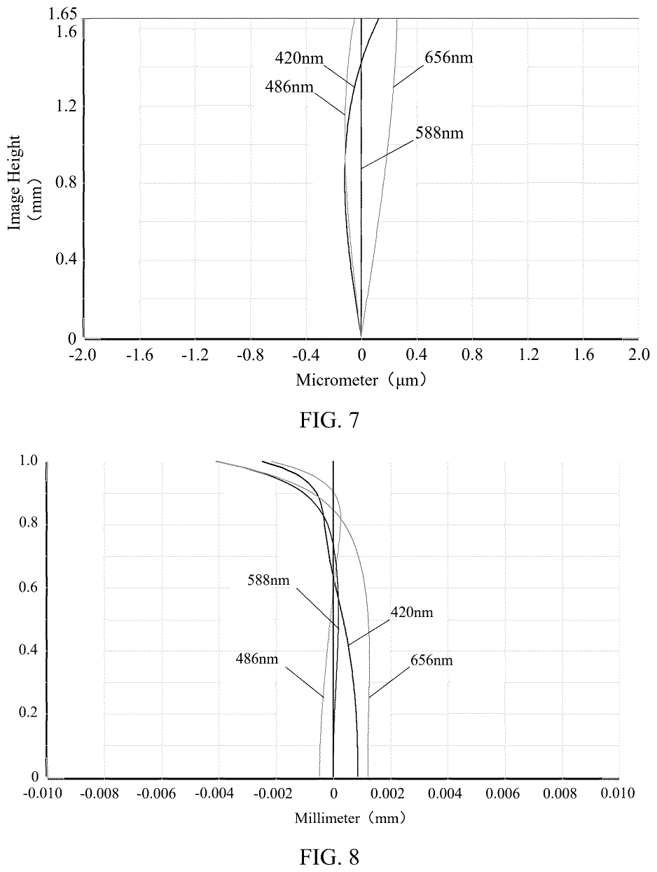

FIG. 6 shows a schematic diagram of field curvature and distortion after light with a wavelength of 588 nm passes through the microscope objective 20 of Example 2, the field curvature S of FIG. 6 is a field curvature in a sagittal direction, and T is a field curvature in a meridian direction. FIG. 7 shows a schematic diagram of lateral color after light with a wavelength of 420 nm, 486 nm, 588 nm and 656 nm passes through the microscope objective 20 of Example 2. FIG. 8 shows a schematic diagram of longitudinal aberration after light with a wavelength of 420 nm, 486 nm, 588 nm and 656 nm passes through the microscope objective 20 of Example 2.

In addition, in the following Table 5, values corresponding to various parameters in Example 2 and parameters defined in the relational expression are also listed.

As shown in Table 5, Example 2 satisfies each relational expression.

In this example, the entrance pupil diameter of the microscope objective 20 is 19.208 mm, the full field of view image height is 1.65 mm, and the numerical aperture is 0.48, the microscope objective 20 can control the path of the light between the lenses, which helps the light to stably propagate after entering the lens group, so that the lens is compact in structure, the total length of the lens is controlled while ensuring that the imaging range reaches the expected state, so that the microscope objective 20 has a large numerical aperture NA, ensures that the light has sufficient convergence capability, has excellent optical performance, and meets the design requirements of low distortion, magnification of 10 times and long working distance.

### Example 3

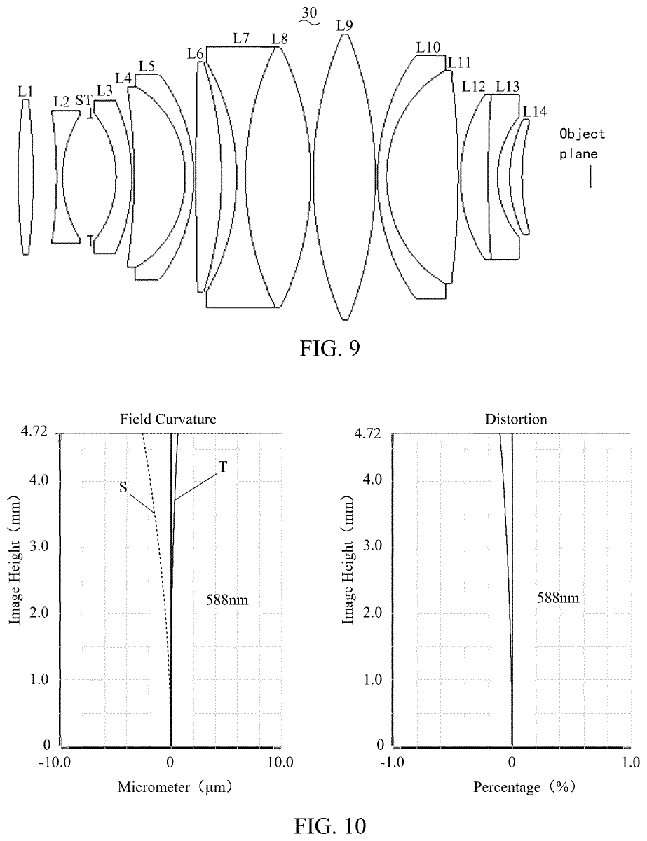

FIG. 9 is a structural schematic diagram of a microscope objective 30 in Example 3, Example 3 is substantially the same as Example 1, the reference signs have the same meaning as Example 1, and only differences are listed below.

Table 3 shows design data of the microscope objective 30 according to Example 3 of the present disclosure.

TABLE 3

| | R | d | | nd | | vd | |
|---|---|---|---|---|---|---|---|
| R1 | 75.173 | d1= | 2.532 | nd1 | 1.9004 | vd1 | 37.372 |
| R2 | -79.013 | d2= | 3.936 | | | | |
| R3 | -55.636 | d3= | 1.000 | nd2 | 1.4970 | vd2 | 81.608 |
| R4 | 15.395 | d41= | 4.688 | | | | |
| ST | ∞ | d42= | 4.284 | / | / | / | / |
| R5 | -13.359 | d5= | 2.260 | nd3 | 1.8697 | vd3 | 20.019 |
| R6 | -23.417 | d6= | 0.399 | | | | |
| R7 | -71.039 | d7= | 8.572 | nd4 | 1.5928 | vd4 | 68.624 |
| R8 | -14.412 | d8= | 0.000 | | | | |
| R9 | -14.412 | d9- | 1.400 | nd5 | 1.7705 | vd5 | 29.736 |
| R10 | -22.099 | d10= | 0.399 | | | | |
| R11 | 545.663 | d11= | 4.257 | nd6 | 1.9229 | vd6 | 20.880 |
| R12 | -47.829 | d12= | 2.542 | | | | |
| R13 | -29.829 | d13= | 1.500 | nd7 | 1.6140 | vd7 | 44.293 |
| R14 | 37.859 | d14= | 0.000 | | | | |
| R15 | 37.859 | d15= | 10.940 | nd8 | 1.4370 | vg8 | 95.100 |
| R16 | -37.342 | d16= | 0.400 | | | | |
| R17 | 46.072 | d17= | 10.398 | nd9 | 1.4370 | vg9 | 95.100 |
| R18 | -48.681 | d18= | 0.399 | | | | |
| R19 | 27.286 | d19= | 1.500 | nd10 | 1.6968 | vg10 | 55.460 |
| R20 | 16.952 | d20= | 0.000 | | | | |
| R21 | 16.952 | d21= | 12.000 | nd11 | 1.4370 | vg11 | 95.100 |
| R22 | -102.524 | d22= | 0.399 | | | | |
| R23 | 19.503 | d23= | 4.629 | nd12 | 1.5503 | vg12 | 75.496 |
| R24 | 147.768 | d24= | 0.000 | | | | |
| R25 | 147.768 | d25= | 1.578 | nd13 | 1.7705 | vg13 | 29.736 |
| R26 | 12.199 | d26= | 2.033 | | | | |
| R27 | 16.562 | d27= | 2.058 | nd14 | 1.9212 | vg14 | 23.956 |
| R28 | 26.103 | d28= | 11.539 | | | | |
| Object | ∞ | / | / | / | / | / | / |
| surface | | | | | | | |

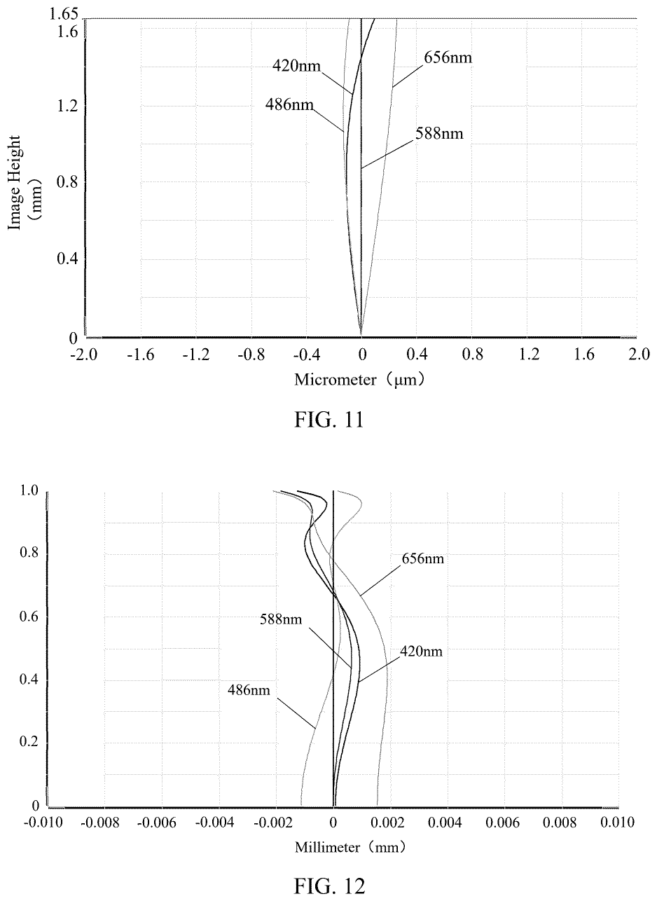

FIG. 10 shows a schematic diagram of field curvature and distortion after light with a wavelength of 588 nm passes through the microscope objective 30 of Example 3, the field curvature S of FIG. 10 is a field curvature in a sagittal direction, and T is a field curvature in a meridian direction. FIG. 11 shows a schematic diagram of lateral color after light with a wavelength of 420 nm, 486 nm, 588 nm and 656 nm passes through the microscope objective 30 of Example 3. FIG. 12 shows a schematic diagram of longitudinal aberration after light with a wavelength of 420 nm, 486 nm, 588 nm and 656 nm passes through the microscope objective 30 of Example 3.

In addition, in the following Table 5, values corresponding to various parameters in Example 3 and parameters defined in the relational expression are also listed.

As shown in Table 5, Example 3 satisfies each relational expression.

In this example, the entrance pupil diameter of the microscope objective 30 is 19.000 mm, the full field of view image height is 1.65 mm, and the numerical aperture NA is 0.475, the microscope objective 30 can control the path of the light between the lenses, which helps the light to stably propagate after entering the lens group, so that the lens is compact in structure, the total length of the lens is controlled while ensuring that the imaging range reaches the expected state, so that the microscope objective 30 has a large numerical aperture NA, ensures that the light has sufficient convergence capability, has excellent optical performance, and meets the design requirements of low distortion, magnification of 10 times and long working distance.

### Example 4

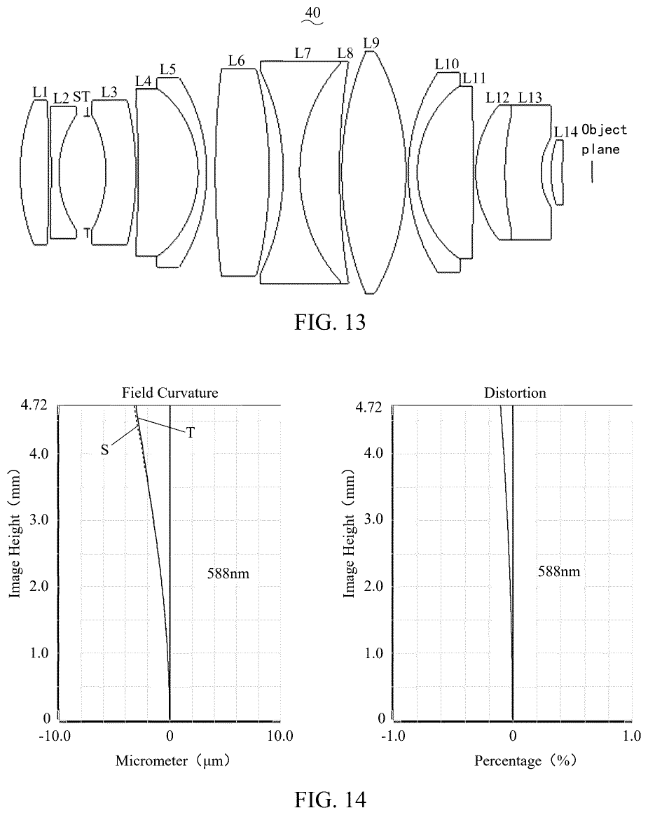

FIG. 13 is a structural schematic diagram of a microscope objective 40 in Example 4, Example 4 is substantially the same as Example 1, the reference signs have the same meaning as Example 1, and only differences are listed below.

In this example, the eighth lens L8 has negative refractive power, and an object-side surface of the eighth lens L8 is concave in a paraxial region.

Table 4 shows design data of the microscope objective 40 as described in the fourth example of the present disclosure.

TABLE 4

| | R | d | | nd | | vd | |
|---|---|---|---|---|---|---|---|
| R1 | 24.970 | d1= | 4.767 | nd1 | 1.8348 | vd1 | 42.721 |
| R2 | -209.817 | d2= | 0.402 | | | | |
| R3 | -321.831 | d3= | 1.279 | nd2 | 1.5935 | vd2 | 67.002 |
| R4 | 13.194 | d41= | 4.737 | | | | |
| ST | ∞ | d42= | 3.123 | / | / | / | / |
| R5 | -15.953 | d5= | 5.000 | nd3 | 1.8697 | vd3 | 20.019 |
| R6 | -38.063 | d6= | 0.400 | | | | |
| R7 | -147.606 | d7= | 10.000 | nd4 | 1.5928 | vd4 | 68.624 |
| R8 | -14.200 | d8= | 0.000 | | | | |
| R9 | -14.200 | d9= | 1.420 | nd5 | 1.7705 | vd5 | 29.736 |
| R10 | -22.627 | d10= | 1.438 | | | | |
| R11 | 110.684 | d11= | 9.000 | nd6 | 1.9229 | vd6 | 20.880 |
| R12 | -52.273 | d12= | 2.347 | | | | |
| R13 | -30.001 | d13= | 2.738 | nd7 | 1.6140 | vd7 | 44.293 |
| R14 | 21.521 | d14= | 0.000 | | | | |
| R15 | 21.521 | d15= | 6.633 | nd8 | 1.4370 | vg8 | 95.100 |
| R16 | 83.458 | d16= | 0.400 | | | | |
| R17 | 40.376 | d17= | 10.703 | nd9 | 1.5714 | vg9 | 71.616 |
| R18 | -31.993 | d18= | 0.400 | | | | |
| R19 | 23.580 | d19= | 1.500 | nd10 | 1.7725 | vg10 | 49.624 |
| R20 | 14.513 | d20= | 0.000 | | | | |
| R21 | 14.513 | d21= | 9.353 | nd11 | 1.4370 | vg11 | 95.100 |
| R22 | -282.524 | d22= | 0.400 | | | | |
| R23 | 14.145 | d23= | 4.893 | nd12 | 1.5714 | vg12 | 71.616 |
| R24 | 34.405 | d24= | 0.000 | | | | |
| R25 | 34.405 | d25= | 6.000 | nd13 | 2.0010 | vg13 | 29.135 |
| R26 | 8.406 | d26= | 1.668 | | | | |
| R27 | 12.855 | d27= | 1.894 | nd14 | 1.5928 | vg14 | 68.624 |
| R28 | 52.020 | d28= | 5.005 | | | | |
| Object | ∞ | / | / | / | / | / | / |
| surface | | | | | | | |

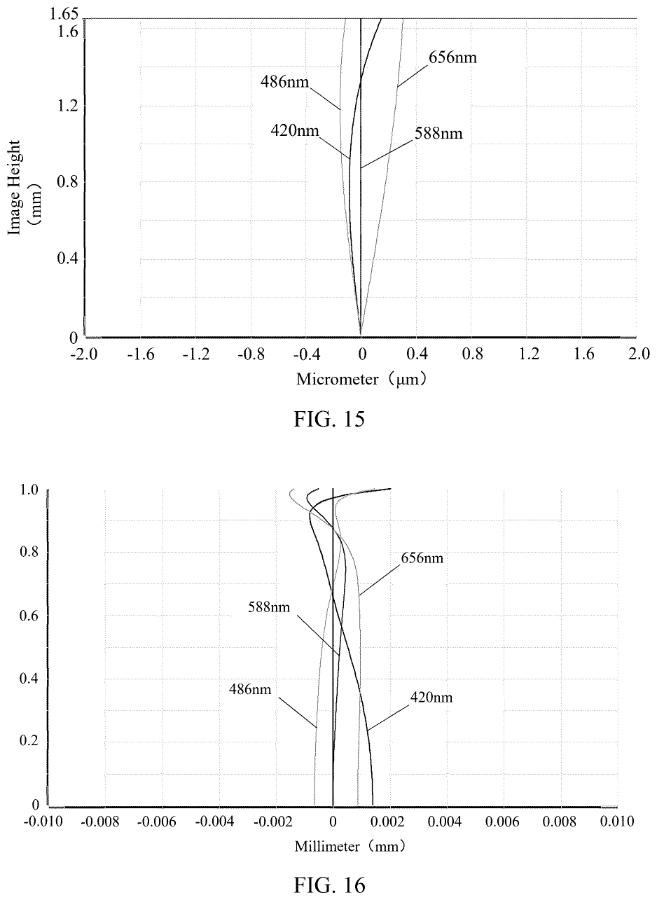

FIG. 14 shows a schematic diagram of field curvature and distortion after light with a wavelength of 555 nm passes through the microscope objective 40 of Example 4, the field curvature S of FIG. 14 is a field curvature in a sagittal direction, and T is a field curvature in a meridian direction; FIG. 15 shows a schematic diagram of lateral color after light with a wavelength of 420 nm, 486 nm, 588 nm and 656 nm passes through the microscope objective 40 of Example 4; and FIG. 16 shows a schematic diagram of longitudinal aberration after light with a wavelength of 420 nm, 486 nm, 588 nm and 656 nm passes through the microscope objective 40 of Example 4.

In addition, in the following Table 5, values corresponding to various parameters in Example 4 and parameters defined in the relational expression are also listed.

As shown in Table 5, Example 4 satisfies each relational expression.

In this example, the entrance pupil diameter of the microscope objective 40 is 19.200 mm, the full field of view image height is 1.65 mm, and the numerical aperture NA is 0.480, the microscope objective 40 can control the path of the light between the lenses, which helps the light to stably propagate after entering the lens group, so that the lens is compact in structure, the total length of the lens is controlled while ensuring that the imaging range reaches the expected state, so that the microscope objective 40 has a large numerical aperture NA, ensures that the light has sufficient convergence capability, has excellent optical performance, and meets the design requirements of low distortion, magnification of 10 times and long working distance.

Table 5 lists values corresponding to each relational expression in the Examples according to the above conditions.

TABLE 5

| Parameters | | | | |
|---|---|---|---|---|
| and Conditional | | | | |
| Expressions | Example 1 | Example 2 | Example 3 | Example 4 |
| f9/f | 2.75 | 3.95 | 2.80 | 1.65 |
| f10_11/f12_13 | −1.95 | −1.41 | −1.69 | −2.95 |
| (R27 + R28)/ | −3.30 | −8.95 | −4.47 | −1.67 |
| (R27 − R28) | | | | |
| WD/TTL | 0.11 | 0.05 | 0.12 | 0.05 |
| WD*NA | 4.85 | 2.40 | 5.48 | 2.40 |
| f | 20.000 | 20.000 | 20.000 | 20.000 |
| f1 | 35.157 | 37.427 | 43.118 | 26.979 |
| f2 | −21.348 | −24.082 | −24.150 | −21.325 |
| f3 | −43.247 | −43.148 | −40.693 | −35.290 |
| f4 | −52.743 | −54.505 | −47.115 | −59.376 |
| f5 | 46.566 | 46.426 | 43.711 | 45.699 |
| f6 | 47.502 | 45.277 | 47.815 | 39.520 |
| f7 | −42.237 | −42.718 | −39.454 | −34.515 |
| f8 | 278.102 | 141.665 | 134.321 | −73.220 |
| f9 | 55.018 | 78.995 | 56.035 | 33.012 |
| f10 | 81.077 | 73.000 | 94.722 | 97.231 |
| f11 | −82.752 | −135.890 | −95.081 | −46.866 |
| f12 | 36.419 | 38.467 | 31.754 | 19.488 |
| f13 | −15.852 | −15.633 | −16.159 | −9.790 |
| f14 | 37.000 | 49.852 | 44.575 | 28.292 |
| f4_5 | 63.162 | 57.329 | 63.332 | 53.974 |
| f7_8 | −73.824 | −90.305 | −89.593 | −28.497 |
| f10_11 | 66.780 | 50.100 | 69.698 | 85.579 |
| f12_13 | −34.293 | −35.512 | −41.131 | −29.010 |
| WD | 10.100 | 5.0006 | 11.539 | 5.005 |
| TTL | 95.500 | 95.500 | 96.001 | 95.500 |
| NA | 0.480 | 0.480 | 0.475 | 0.480 |
| ENPD | 19.208 | 19.208 | 19.000 | 19.200 |

The microscope objective provided by the examples of the present disclosure are described in detail above, the principles and the embodiments of the present disclosure are described herein by using specific examples, and the description of the above embodiments is only used to help understand the concept of the present disclosure, and there will be changes in the embodiments and application ranges, and in summary, the contents of the present disclosure should not be construed as limiting the present disclosure.

What is claimed is:

1. A microscope objective, sequentially comprising from an exit side to an object side: a first lens having positive refractive power, a second lens having negative refractive power, a third lens having negative refractive power, a fourth lens having negative refractive power, a fifth lens having positive refractive power, a sixth lens having positive refractive power, a seventh lens having negative refractive power, an eighth lens having positive or negative refractive power, a ninth lens having positive refractive power, a tenth lens having positive refractive power, an eleventh lens having negative refractive power, a twelfth lens having positive refractive power, a thirteenth lens having negative refractive power, and a fourteenth lens having positive refractive power;
wherein a focal length of the ninth lens is f9, a combined focal length of the tenth lens and the eleventh lens is f10_11, a combined focal length of the twelfth lens and the thirteenth lens is f12_13, a curvature radius of an exit surface of the fourteenth lens is R27, a curvature radius of an object-side surface of the fourteenth lens is R28, a focal length of the microscope objective is f, an on-axis distance from an object surface of the microscope objective to the object surface of the fourteenth lens is WD, an on-axis distance from the object-side surface of the microscope objective to an exit surface of the first lens is TTL, and a numerical aperture of the microscope objective is NA, and following relational expressions are satisfied:
$$1.6 \leq f 9 / f \leq 4. ;$$
$$- 3. \leq f10\_ 11 / f12\_ 13 \leq - 1.4 ;$$
$$- 9. 0 \leq ( R 27 + R 28 ) / ( R 27 - R 28 ) \leq - 1.6 ;$$
$$0.05 \leq WD / TTL \leq 0.13 ; and$$
$$2.4 \leq WD * NA \leq 5.5 .$$

2. The microscope objective as described in claim 1, wherein an object-side surface of the fourth lens and an exit surface of the fifth lens are glued to form a first combined lens, an object-side surface of the seventh lens and an exit surface of the eighth lens are glued to form a second combined lens, an object-side surface of the tenth lens and an exit surface of the eleventh lens are glued to form a third combined lens, an object-side surface of the twelfth lens and an exit surface of the thirteenth lens are glued to form a fourth combined lens, and a difference in Abbe number between two lenses in any one combined lens is Δv, and a following relational expression is satisfied:
$$Δ v \geq 35. .$$

3. The microscope objective as described in claim 1, wherein an exit surface of the first lens is convex in a paraxial region, and an object-side surface of the first lens is convex in the paraxial region;
a curvature radius of an exit surface of the first lens is R1, a curvature radius of an object-side surface of the first lens is R2, a focal length of the first lens is f1, and an on-axis thickness of the first lens is d1, and following relational expressions are satisfied:
$$- 1.57 \leq ( R 1 + R 2 ) / ( R 1 - R 2 ) \leq 0. ;$$
$$0.67 \leq f 1 / f \leq 3.23 ; and$$
$$0.01 \leq d 1 / TTL \leq 0.07 .$$

4. The microscope objective as described in claim 1, wherein an exit surface of the second lens is concave in a paraxial region, and an object-side surface of the second lens is concave in the paraxial region;
a curvature radius of an exit surface of the second lens is R3, a curvature radius of an object-side surface of the second lens is R4, a focal length of the second lens is f2, and an on-axis thickness of the second lens is d3, and following relational expressions are satisfied:
$$0.22 \leq ( R 3 + R 4 ) / ( R 3 - R 4 ) \leq 1.38 ;$$
$$- 2.4 \; 1 \leq f 2 / f \leq - 0 \text{.71} ; and$$
$$0.01 \leq d 3 / TTL \leq 0.02 .$$

5. The microscope objective as described in claim 1, wherein an exit surface of the third lens is concave in a paraxial region, and an object-side surface of the third lens is convex in the paraxial region;
a curvature radius of an exit surface of the third lens is R5, a curvature radius of an object-side surface of the third lens is R6, a focal length of the third lens is f3, and an on-axis thickness of the third lens is d5, and following relational expressions are satisfied:
$$- 7.51 \leq ( R 5 + R 6 ) / ( R 5 - R 6 ) \leq - 1.63 ;$$
$$- 4.3 \; 3 \leq f 3 / f \leq - 1 \text{.18} ; and$$
$$0.01 \leq d 5 / TTL \leq 0.08 .$$

6. The microscope objective as described in claim 1, wherein an exit surface of the fourth lens is concave in a paraxial region, and an object-side surface of the fourth lens is convex in the paraxial region;
a curvature radius of an exit surface of the fourth lens is R7, a curvature radius of an object-side surface of the fourth lens is R8, a focal length of the fourth lens is f4, and an on-axis thickness of the fourth lens is d7, and following relational expressions are satisfied:
$$0.61 \leq ( R 7 + R 8 ) / ( R 7 - R 8 ) \leq 2.26 ;$$
$$- 5.94 \leq f 4 / f \leq - 1.57 ; and$$
$$0.04 \leq d 7 / TTL \leq 0.16 .$$

7. The microscope objective as described in claim 1, wherein an exit surface of the fifth lens is concave in a paraxial region, and an object-side surface of the fifth lens is convex in the paraxial region;
a curvature radius of an exit surface of the fifth lens is R9, a curvature radius of an object-side surface of the fifth lens is R10, a focal length of the fifth lens is f5, and an on-axis thickness of the fifth lens is d9, and following relational expressions are satisfied:
$$- 9.5 \leq ( R 9 + R 10 ) / ( R 9 - R 10 ) \leq - 2.61 ;$$
$$1.09 \leq f 5 / f \leq 3.49 ; and$$
$$0.01 \leq d 9 / TTL \leq 0.06 .$$

8. The microscope objective as described in claim 1, wherein an object-side surface of the fourth lens and an exit surface of the fifth lens are glued to form a combined lens having positive refractive power, and a combined focal length of the fourth lens and the fifth lens is f4_5, and a following relational expression is satisfied:
$$135 \leq f 4 \_ 5 / f \leq 4.75 .$$

9. The microscope objective as described in claim 1, wherein an exit surface of the sixth lens is convex in a paraxial region, and an object-side surface of the sixth lens is convex in the paraxial region;
a curvature radius of an exit surface of the sixth lens is R11, a curvature radius of an object-side surface of the sixth lens is R12, a focal length of the sixth lens is f6, and an on-axis thickness of the sixth lens is d11, and following relational expressions are satisfied:
$$0.18 \leq ( R 11 + R 12 ) / ( R 11 - R 12 ) \leq 1.26 ;$$
$$0.98 \leq f 6 / f \leq 3.59 ; and$$
$$0.02 \leq d 11 / TTL \leq 0.14 .$$

10. The microscope objective as described in claim 1, wherein an exit surface of the seventh lens is convex in a paraxial region, and an object-side surface of the seventh lens is concave in the paraxial region;
a curvature radius of an exit surface of the seventh lens is R13, a curvature radius of an object-side surface of the seventh lens is R14, a focal length of the seventh lens is f7, and an on-axis thickness of the seventh lens is d13, and following relational expressions are satisfied:
$$- 0.43 \leq ( R 13 + R 14 ) / ( R 13 - R 14 ) \leq 0.25 ;$$
$$- 4.27 \leq f 7 / f \leq - 1.15 ; and$$
$$0.01 \leq d 13 / TTL \leq 0.04 .$$

11. The microscope objective as described in claim 1, wherein an exit surface of the eighth lens is concave in a paraxial region;
a curvature radius of an exit surface of the eighth lens is R15, a curvature radius of an object-side surface of the eighth lens is R16, a focal length of the eighth lens is f8, and an on-axis thickness of the eighth lens is d15, and following relational expressions are satisfied:
$$- 3.39 \leq ( R 15 + R 16 ) / ( R 15 - R 16 ) \leq 0.11 ;$$
$$- 7.32 \leq f 8 / f \leq 20.86 ; and$$
$$0.03 \leq d 15 / TTL \leq 0.17 .$$

12. The microscope objective as described in claim 1, wherein an object-side surface of the seventh lens and an exit surface of the eighth lens are glued to form a combined lens having negative refractive power, and a combined focal length of the seventh lens and the eighth lens is f7_8, and a following relational expression is satisfied:
$$- 9.03 \leq f 7 \_ 8 / f \leq - 0.95 .$$

13. The microscope objective as described in claim 1, wherein an exit surface of the ninth lens is concave in a paraxial region, and an object-side surface of the ninth lens is convex in the paraxial region;
a curvature radius of an exit surface of the ninth lens is R17, a curvature radius of an object-side surface of the ninth lens is R18, and an on-axis thickness of the ninth lens is d17, and following relational expressions are satisfied:
$$- 0.06 \leq ( R 17 + R 18 ) / ( R 17 - R 18 ) \leq 0.6 ; and$$
$$0.03 \leq d 17 / TTL \leq 0.17 .$$

14. The microscope objective as described in claim 1, wherein an exit surface of the tenth lens is concave in a paraxial region, and an object-side surface of the tenth lens is concave in the paraxial region;
a curvature radius of an exit surface of the tenth lens is R19, a curvature radius of an object-side surface of the tenth lens is R20, a focal length of the tenth lens is f10, and an on-axis thickness of the tenth lens is d19, and following relational expressions are satisfied:
$$2.1 \leq ( R 19 + R 20 ) / ( R 19 - R 20 ) \leq 8.39 ;$$
$$1.83 \leq f 10 / f \leq 7.29 ; and$$
$$0.01 \leq d 19 / TTL \leq 0.02 .$$

15. The microscope objective as described in claim 1, wherein an exit surface of the eleventh lens is concave in a paraxial region, and an object-side surface of the eleventh lens is convex in the paraxial region;
a curvature radius of an exit surface of the eleventh lens is R21, a curvature radius of an object-side surface of the eleventh lens is R22, a focal length of the eleventh lens is f11, and an on-axis thickness of the eleventh lens is d21, and following relational expressions are satisfied:
$$- 1.8 \leq ( R 21 + R 22 ) / ( R 21 - R 22 ) \leq - 0.38 ;$$
$$- 13.59 \leq f 11 / f \leq - 1.56 ; and$$
$$0.05 \leq d 21 / TTL \leq 0.19 .$$

16. The microscope objective as described in claim 1, wherein an object-side surface of the tenth lens and an exit surface of the eleventh lens are glued to form a combined lens having positive refractive power, and a following relational expression is satisfied:
$$1.25 \leq f 10 \_ 11 / f \leq 6.42 .$$

17. The microscope objective as described in claim 1, wherein an exit surface of the twelfth lens is concave in a paraxial region, and an object-side surface of the twelfth lens is concave or convex in the paraxial region;
a curvature radius of an exit surface of the twelfth lens is R23, a curvature radius of an object-side surface of the twelfth lens is R24, a focal length of the twelfth lens is f12, and an on-axis thickness of the twelfth lens is d23, and following relational expressions are satisfied:
$$- 4.79 \leq ( R 23 + R 24 ) / ( R 23 - R 24 ) \leq - 0.41 ;$$
$$0.49 \leq f 12 / f \leq 2.89 ; and$$
$$0.02 \leq d 23 / TTL \leq 0.08 .$$

18. The microscope objective as described in claim 1, wherein an object-side surface of the thirteenth lens is concave in a paraxial region;
a curvature radius of an exit surface of the thirteenth lens is R25, a curvature radius of an object-side surface of the thirteenth lens is R26, a focal length of the thirteenth lens is f13, and an on-axis thickness of the thirteenth lens is d25, and following relational expressions are satisfied:
$$0.36 \leq ( R 25 + R 26 ) / ( R 25 - R 26 ) \leq 2.47 ;$$
$$- 1.62 \leq f 13 / f \leq - 0.33 ; and$$
$$0.01 \leq d 25 / TTL \leq 0.09 .$$

19. The microscope objective as described in claim 1, wherein an object-side surface of the twelfth lens and an exit surface of the thirteenth lens are glued to form a combined lens having negative refractive power, and a following relational expression is satisfied:
$$- 4.11 \leq f 12 \_ 13 / f \leq - 0.97 .$$

20. The microscope objective as described in claim 1, wherein an exit surface of the fourteenth lens is concave in a paraxial region, and an object-side surface of the fourteenth lens is concave in the paraxial region;
a focal length of the fourteenth lens is f14, and an on-axis thickness of the fourteenth lens is d27, and following relational expressions are satisfied:
$$0.71 \leq f 14 / f \leq 3.74 ; and$$
$$0.01 \leq d 27 / TTL \leq 0.15 .$$
